(19) United States
(12) Patent Application Publication
(10) Pub. No.: US 2025/0203359 A1
(43) Pub. Date: Jun. 19, 2025

(54) UNIVERSAL INTEGRATED MULTI-SERVICE ENTITY MANAGEMENT SYSTEM FOR STREAMLINED OPERATIONS

(71) Applicant: Wells Fargo Bank, N.A., San Francisco, CA (US)

(72) Inventors: Debashis Ghosh, Charlotte, NC (US); Justin Blackburn, Litchfield Park, AZ (US)

(21) Appl. No.: 18/540,401

(22) Filed: Dec. 14, 2023

(51) Int. Cl. H04W 12/06; H04L 9/32; H04L 9/40

(52) U.S. Cl. CPC H04W 12/06; H04L 9/3213; H04L 63/0876

(57) ABSTRACT

Systems, apparatuses, methods, and computer program products are disclosed for facilitating operations for a user with a service entity. An example method includes receive a service entity request pertaining to the user. The example method further includes determining a service entity configuration set for the service entity and initiating a session with the service entity device. The example method further includes receiving a session establishment response from the service entity device. The example method further includes generating service entity user interface data and providing the service entity user interface data to an auxiliary device.

### BACKGROUND

Currently, service entities may offer certain products and/or services at physical, brick-and-mortar locations operated by the service entity. While some of these products or services may be available in a virtual format, other services may be only offered at these physical locations.

### BRIEF SUMMARY

As described above, brick and mortar locations that are operated by service entities may provide various services to customers. For example financial institution service entities may use brick and mortar bank branches to facilitate various financial services for customers. While bank branches were once the cornerstone of banking services, they are increasingly viewed as inefficient and outdated in the modern financial landscape. In particular, the advent of digital banking has dramatically altered the way customers interact with financial institutions as online and mobile banking platforms offer the convenience of performing many operations remotely, thereby reducing the need for physical bank branch visits. This shift in behavior has rendered many bank branches underutilized, leading to a significant mismatch in operating costs versus actual usage. Furthermore, the traditional model of limited hours and location-dependent access for bank branches is inferior to the 24/7 availability and global accessibility offered by digital banking.

However, digital banking platforms are not currently capable of facilitating certain operations for the customer and thus customers are required to visit a bank branch to perform these activities. For example, customers may still be required to visit a bank branch to access a safety deposit box, notarize documents, for more complex services (e.g., wealth management, estate planning, account disputes, or the like), obtaining a cashier's check, opening user accounts, immediate card replacements, and/or the like. Thus, bank branches are still required to facilitate the full range of services and products.

In contrast to convention bank branches, example embodiments described herein address these inefficiencies by contemplating a system that acts as a universal point of service, agnostic to any one particular financial institution, and capable of allowing customers of any financial institution to perform actions for their user accounts with various financial institutions. Thus, example embodiments described herein provide a significant technical improvement to current user account operations and management by leveraging advanced inter-service entity communications to enable a streamlined and unified banking experience that has not been traditionally available. This solution drastically reduces the redundancy of having multiple bank branches associated with different financial institutions operating in close proximity by consolidating services into a single location, thereby allowing for a more efficient user of physical space and personnel.

In order to facilitate the above described system, the present disclosure sets forth systems, methods, and apparatuses that are configured to receive a service entity request that pertains to a user. The service entity request may include an indication of a service entity of interest. A corresponding service entity configuration set may then be used to determine various parameters for the particular service entity and a service entity device that may be used to facilitate a session for the user. A secure session may then be established with the service entity device. The session may use APIs. Through the use of APIs amongst each possible service entity, system may facilitate a standardized method of communication between disparate service entity systems. This ensures that regardless of the underlying technology or data used by various service entities, there is a common structure for data exchange, thus allowing for interoperability between the system and multiple service entities. Furthermore, APIs may enable real-time data access and processing to facilitate seamless operations for the user. Additionally, the use of APIs provides a scalable architecture that can accommodate new service entities or expansion of services. The service entity configuration set may be tailored for each service entity and may correspond to the API structure such that the system may generate service entity user interface data that mimics what the user may expect to see from the service entity.

Example embodiments described herein additionally allow for multiple sessions to be established with different service entities for the user. The capability for establishing multiple sessions with disparate service entities has not traditionally been available. However, by utilizing the flexible and scalable architecture of communication system described herein, the multiple session capability may be readily realized. Furthermore, in some embodiments, the system may use establish and maintain sessions with different service entity devices simultaneously, via parallel processing, such that various communications and operations between a system device and various service entity devices may be performed real time or near real time. Thus, this may allow users to manage user accounts across multiple service entities in real time or near real time.

Additionally, the flexible architecture of embodiments described herein allows for the system to be implemented within any physical branch, including mobile branches capable of changing location in response to user need. For example, the system may be implemented within mobile branch, such as a mobile vehicle, a mobile tent, or other mobile structure. A physical branch capable of mobility in addition to facilitating user account services for multiple service entities may provide superior accessibility and convenience to users.

Furthermore, example embodiments described herein may leverage artificial intelligence models to generate an agent script for an agent associated with the system in order to facilitate efficient and accurate communications between the agent and user, regardless of the service entity the user is associated with. Alternatively, in some example embodiments, a virtual agent may be rendered and used to facilitate user interaction. The rendered virtual agent may mimic the appearance of agents typically associated with a service entity. Thus, example embodiments contemplate leveraging artificial intelligence to create facilitate user interactions that simulate user interactions the user would experience at a traditional service entity location.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used to facilitate service requests for a user with multiple service entities.

FIG. 2 illustrates a schematic block diagram of example circuitry embodying a system device that may perform various operations in accordance with some example embodiments described herein.

FIG. 3 illustrates a schematic block diagram of example circuitry embodying a service entity device that may perform various operations in accordance with some example embodiments described herein.

FIG. 4 illustrates an example flowchart for generating and providing service entity user interface data to a user for a service entity, in accordance with some example embodiments described herein.

FIG. 5 illustrates an example flowchart for generating and providing a service entity operation response to facilitate a service request for the user with a service entity, in accordance with some example embodiments described herein.

FIG. 6 illustrates an example flowchart for providing an agent script to an agent to facilitate interaction between the agent and the user, in accordance with some example embodiments described herein.

FIG. 7 illustrates an example flowchart for generating and providing a virtual agent object to facilitate interaction between the virtual agent and the user, in accordance with some example embodiments described herein.

FIG. 8 illustrates an example flowchart for handling an escalation request, in accordance with some example embodiments described herein.

FIG. 9 illustrates an example flowchart for terminating a session with a service entity device, in accordance with some example embodiments described herein.

FIG. 10 illustrates an example flowchart for generating and providing second service entity user interface data to a user for a second service entity, in accordance with some example embodiments described herein.

FIG. 11 illustrates an example flowchart for generating and providing a future operation location for a physical branch associated with the operation management system, in accordance with some example embodiments described herein.

FIG. 12 illustrates an example flowchart for establishing a session with a system device, in accordance with some example embodiments described herein.

FIG. 13 illustrates an example flowchart for providing a service entity operation response, in accordance with some example embodiments described herein.

FIG. 14 illustrates an example flowchart for handling a live user session request, in accordance with some example embodiments described herein.

FIG. 15 illustrates an example flowchart for terminating a session with the system device, in accordance with some example embodiments described herein.

FIGS. 16A, 16B, 16C, and 16D illustrate swim lane diagrams with example operations that may be used to establish a session between a system device and service entity device and may be performed by components of the environment depicted in FIG. 1, in accordance with some example embodiments described herein.

FIG. 17 illustrates a swim lane diagram with example operations that may be used to facilitate a live user session as performed by components of the environment depicted in FIG. 1, in accordance with some example embodiments described herein.

FIG. 18 illustrates a swim lane diagram with example operations that may be used to provide an agent script to an agent as performed by components of the environment depicted in FIG. 1, in accordance with some example embodiments described herein.

FIG. 19 illustrates a swim lane diagram with example operations that may be used to generate and provide a virtual agent object as performed by components of the environment depicted in FIG. 1, in accordance with some example embodiments described herein.

FIG. 20 illustrates a swim lane diagram with example operations that may be used to terminate a session between a system device and service entity device as performed by components of the environment depicted in FIG. 1, in accordance with some example embodiments described herein.

FIGS. 21A and 21B illustrate swim lane diagrams with example operations that may be used to establish a session between a system device and second service entity device that may be performed by components of the environment depicted in FIG. 1, in accordance with some example embodiments described herein.

FIG. 22 illustrates an example user interface of an example service user interface data GUI used in some example embodiments described herein.

FIG. 23 depicts an example session establishment request for a restless API as used in some example embodiments described herein.

FIGS. 24A, 24B, and 24C depict example upgrade requests and a session establishment request for a restful API as used in some example embodiments described herein.

FIG. 25 depicts an example session establishment response for a restless API as used in some example embodiments described herein.

FIG. 26 depicts an example session establishment response for a restful API as used in some example embodiments described herein.

FIG. 27 depicts an example service entity operation request for a restless API as used in some example embodiments described herein.

FIG. 28 depicts an example service entity operation request for a restful API as used in some example embodiments described herein.

FIG. 29 depicts an example service entity operation response for a restless API as used in some example embodiments described herein.

FIG. 30 depicts an example service entity operation response for a restful API as used in some example embodiments described herein.

FIG. 31 depicts an example session termination request for a restless API as used in some example embodiments described herein.

FIG. 32 depicts an example session termination request for a restful API as used in some example embodiments described herein.

FIG. 33 depicts an example session termination response for a restless API as used in some example embodiments described herein.

FIG. 34 depicts an example session termination response for a restful API as used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

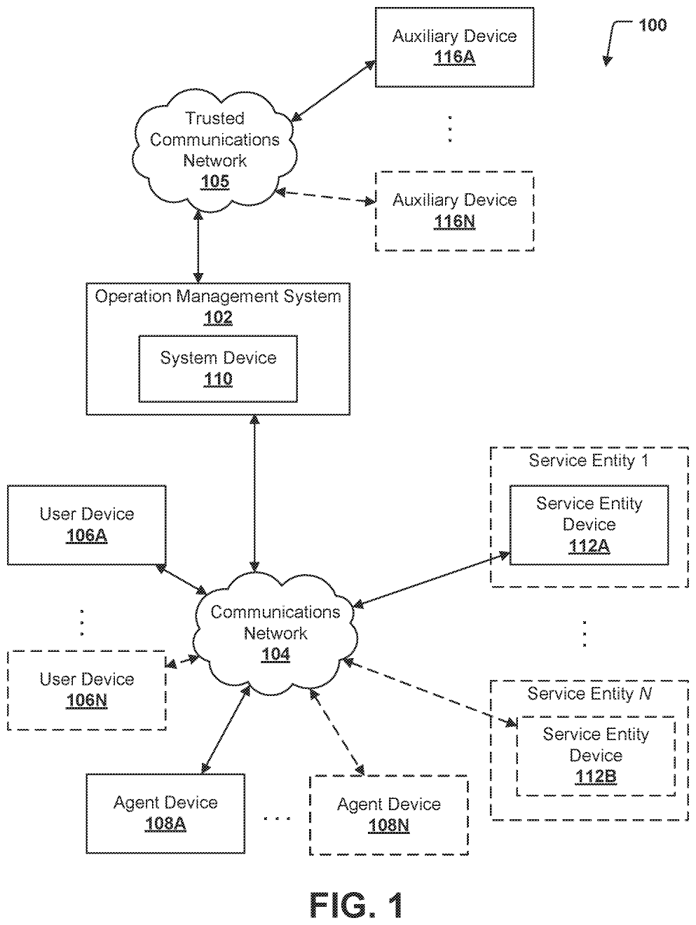

Example embodiments described herein may be implemented using any of a variety of computing devices or servers. To this end, FIG. 1 illustrates an example environment 100 within which various embodiments may operate. As illustrated, an operation management system 102 may receive and/or transmit information via communications network 104 (e.g., the Internet) with any number of other devices, such as one or more of user devices 106A-106N, one or more agent devices 108A-108N, and/or one or more service entity devices 112A-112N. Additionally, the operation management system 102 may receive and/or transmit information via trusted communications network 105 (e.g., an Intranet), which may be a private or restricted communication environment within which only certain, authorized devices may communicate, such as auxiliary devices 116A-116N.

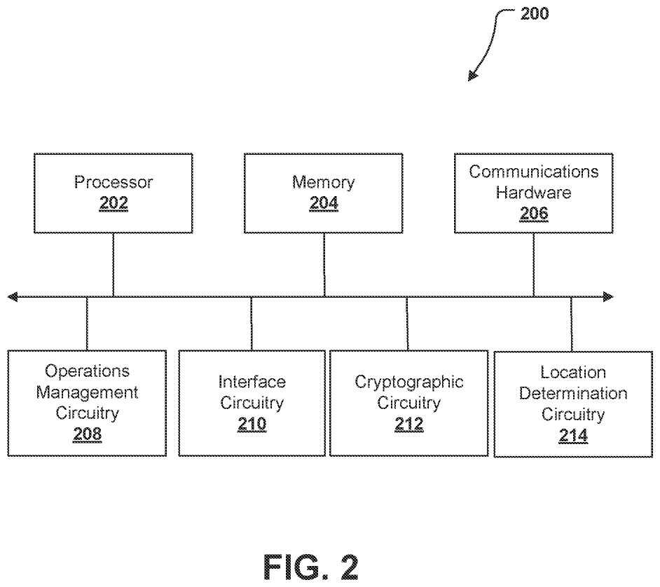

The operation management system 102 may be implemented as one or more computing devices or servers, which may be composed of a series of components. Particular components of the operation management system 102 are described in greater detail below with reference to apparatus 200 in connection with FIG. 2.

In some embodiments, the operation management system 102 further includes a storage device that comprises a distinct component from other components of the operation management system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The storage device may host the software executed to operate the operation management system 102. The storage device may store information relied upon during operation of the operation management system 102, such as various models and/or service entity configuration sets, that may be used by the operation management system 102, data and documents to be analyzed using the operation management system 102, or the like. In addition, the storage device may store control signals, device characteristics, and access credentials enabling interaction between the operation management system 102 and one or more of the user devices 106A-106N, agent devices 108A-108N, service entity devices 112A-112N, and/or auxiliary devices 116A-116N.

The one or more user devices 106A-106N, agent devices 108A-108N, service entity devices 112A-112N, and/or auxiliary devices 116A-116N may be embodied by any computing devices known in the art. The one or more user devices 106A-106N, agent devices 108A-108N, service entity devices 112A-112N, and/or auxiliary devices 116A-116N need not themselves be independent devices, but may be peripheral devices communicatively coupled to other computing devices.

### Example Implementing Apparatuses

### Example System Device

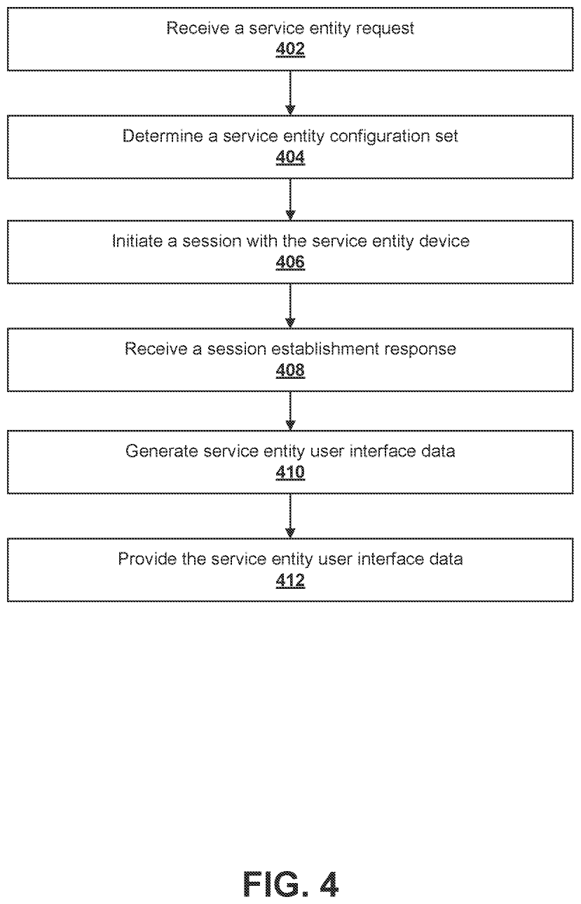

The operation management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-11. As illustrated in FIG. 2, the apparatus 200 may include processor 202, memory 204, communications hardware 206, operations management circuitry 208, interface circuitry 210, cryptographic circuitry 212, and location determination circuitry 214, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processor for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises operations management circuitry 208 that may be configured to determine a service entity configuration set, generate session establishment requests, generate service entity operation requests, determine a session termination event, generate a session termination request, and/or the like. The operations management circuitry 208 may utilize processor 202, memory 204, or any other hardware component included in the apparatus 200 to perform these operations, as described in connection with FIGS. 4-11 below. The operations management circuitry 208 may further utilize communications hardware 206 to gather data from a variety of sources (e.g., user devices 106A-106N, agent devices 108A-108N, service entity devices 112A-112N, and/or auxiliary devices 116A-116N, as shown in FIG. 1), and/or exchange data with a user.

In addition, the apparatus 200 further comprises interface circuitry 210 that may be configured to generate service entity user interface data and/or the like. The interface circuitry 210 may utilize processor 202, memory 204, or any other hardware component included in the apparatus 200 to perform these operations, as described in connection with FIGS. 4-11 below. The interface circuitry 210 may further utilize communications hardware 206 to gather data from a variety of sources (e.g., user devices 106A-106N, agent devices 108A-108N, service entity devices 112A-112N, and/or auxiliary devices 116A-116N, as shown in FIG. 1), and/or exchange data with a user.

In addition, the apparatus 200 further comprises location determination circuitry 214 that may be configured to determine future operation locations and/or operating hours and/or the like. The location determination circuitry 214 may utilize processor 202, memory 204, or any other hardware component included in the apparatus 200 to perform these operations, as described in connection with FIGS. 4-11 below. The location determination circuitry 214 may further utilize communications hardware 206 to gather data from a variety of sources (e.g., user devices 106A-106N, agent devices 108A-108N, service entity devices 112A-112N, and/or auxiliary devices 116A-116N, as shown in FIG. 1), and/or exchange data with a user.

Although components 202-214 are described in part using functional language, it will be understood that the particular implementations necessarily include the use of particular hardware. It should also be understood that certain of these components 202-214 may include similar or common hardware. For example, the operations management circuitry 208, interface circuitry 210, cryptographic circuitry 212, and location determination circuitry 214 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the operations management circuitry 208, interface circuitry 210, cryptographic circuitry 212, and location determination circuitry 214 may leverage processor 202, memory 204, or communications hardware 206 as described above, it will be understood that any of operations management circuitry 208, interface circuitry 210, cryptographic circuitry 212, and location determination circuitry 214 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that operations management circuitry 208, interface circuitry 210, cryptographic circuitry 212, and location determination circuitry 214 comprise particular machinery designed for performing the functions described herein in connection with such elements of apparatus 200.

### Example Service Entity Device

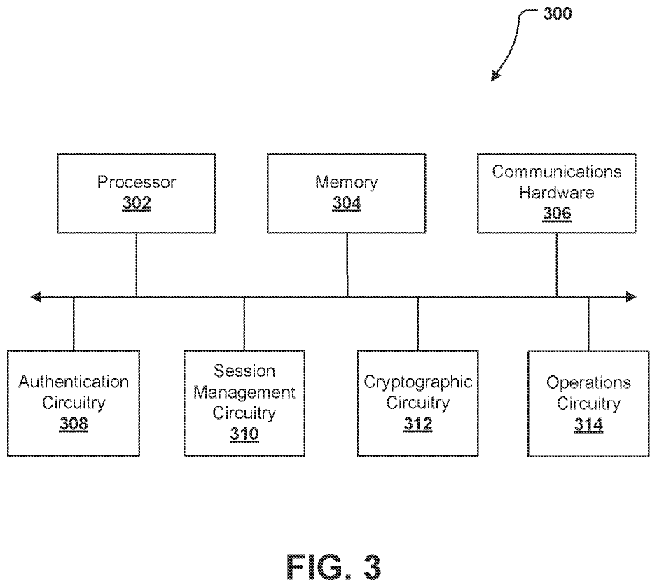

As illustrated in FIG. 3, an apparatus 300 is shown that represents an example service entity device (e.g., any of service entity devices 112A-112N). The apparatus 300 includes processor 302, memory 304, communications hardware 306, and cryptographic circuitry 312, each of which is configured to be similar to the similarly named components described above in connection with FIG. 2.

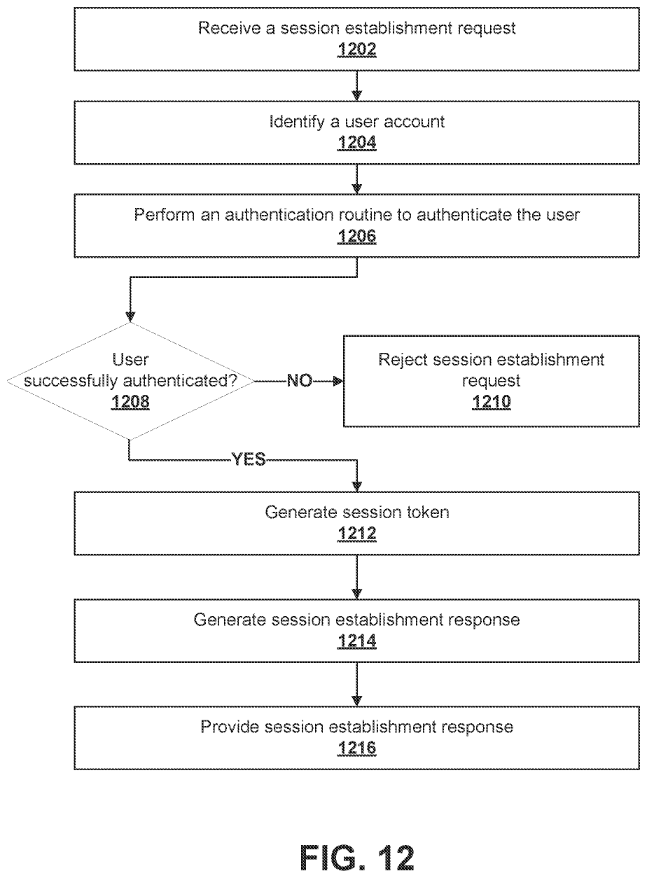

However, the apparatus 300 also includes authentication circuitry 308, which includes hardware components configured to authenticate a user for a session. The authentication circuitry 308 may utilize processor 302, memory 304, or any other hardware component included in the apparatus 300 to perform these operations, as described in connection with FIGS. 12-15 below.

Apparatus 300 may also include session management circuitry 310, which includes hardware components configured to generate a session token for a session. The session management circuitry 310 may utilize processor 302, memory 304, or any other hardware component included in the apparatus 300 to perform these operations, as described in connection with FIGS. 12-15 below.

Apparatus 300 may also include operations circuitry 314, which includes hardware components configured to perform an operational flow for a user account, generate responses, facilitate a live user session, and/or the like. The operations circuitry 314 may utilize processor 302, memory 304, or any other hardware component included in the apparatus 300 to perform these operations, as described in connection with FIGS. 12-15 below.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of graphical user interfaces and flowcharts.

### Example Operations

### System Device Operations

Turning to FIGS. 4-11, example flowcharts are illustrated that contain example operations implemented by example embodiments described herein. The operations illustrated in FIGS. 4-11 may, for example, be performed by system device 110 of the operation management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, operations management circuitry 208, interface circuitry 210, cryptographic circuitry 212, location determination circuitry 214, and/or any combination thereof. It will be understood that user interaction with the operation management system 102 may occur directly via communications hardware 206, or may instead be facilitated by a separate device, such as user device (e.g., any one of user devices 106A-106N), agent device (e.g., any one of agent devices 108A-108N), service entity device (e.g., any one of service entity devices 112A-112N), and/or auxiliary devices (e.g., any one of auxiliary devices 116A-116N), as shown in FIG. 1, and which may have similar or equivalent physical componentry facilitating such user interaction.

Turning first to FIG. 4, example operations are shown for establishing and facilitating a session with a service entity device of a service entity for a user. In some embodiments, a user may visit a physical branch, which may be a brick-and-mortar location or may be mobile, that is associated with apparatus 200. The user may wish to perform various operations with one or more service entities. To facilitate this, apparatus 200 may establish a secure session with a service entity device of a service entity of interest as indicated by the user. Upon establishment of the secure session, apparatus 200 may receive user account data such that this data and service entity user interface data may be generated. The apparatus 200 may provide the service entity user interface data to an auxiliary device that is configured to cause display of this data to a user. Thus, a user may view his/her account details for a user account with the service entity on the auxiliary device. To facilitate this, apparatus 200 may utilize a new communication protocol with service entity devices, as described in greater detail below. This communication protocol enables a streamlined and efficient communication process, whereby a recipient service entity device may be capable of facilitating various operations and services in real-time or near real-time, thereby paralleling a user experience indistinguishable from a user experience using a conventional service entity specific system.

As shown by operation 402, the apparatus 200 includes means, such as processor 202, memory 204, communications hardware 206, operations management circuitry 208, or the like, for receiving a service entity request. A service entity request may be indicative of a request for apparatus 200 to facilitate a secure session between a user and a particular service entity. The service entity request may include an indication of a service entity identity that corresponds to the service entity of interest to the user. Additionally, the service entity request may include a user identifier for the user and a user credential for the user. The user identifier and user credential for the user may be associated with the requested service entity. Thus, provision of the user identifier and user credential to an associated service entity device may allow the service entity to authenticate the user and/or identify a user account. In some embodiments, communications hardware may be configured to receive the service entity request from an auxiliary device (e.g., auxiliary device 116A-116N).

As described above, the user may visit a physical branch, which may be a brick-and-mortar location or may be mobile, that is associated with apparatus 200. The physical branch may include one or more auxiliary devices (e.g., auxiliary device 116A-116N). The auxiliary devices may be located within the physical branch. Furthermore, an auxiliary device may communicatively connected to apparatus 200 via a secure network (e.g., trusted communications network 105). By way of particular example, the physical branch may be a physical, brick-and-mortar location and the auxiliary device may be a computing device located within the physical brick-and-mortar location. Alternatively, the physical branch may be mobile branch (e.g., a mobile van, a mobile tent, or other mobile structure) such that the location of the physical branch may change. The auxiliary device may be a computing device that is transported or otherwise associated with the structure of the mobile branch. The auxiliary device may be configured to interact directly with the user or a user device of the user while the user is within a proximity interaction region of the physical branch. For example, an auxiliary device may be a touchscreen device, Bluetooth reader, near-field communication (NFC) reader, radio frequency identification (RFID) reader, card reader, wireless device, or another computing device that can interact directly with the user and/or a user device of the user. The proximity interaction region may be a defined geographic region within which a user may interact with the auxiliary device. The proximity interaction region may be defined to encompass a geographic location that ensures the user must be nearby the auxiliary device and/or within the associated physical location.

The communications hardware 206 may be configured to receive the service entity request pertaining to a user in various ways. For example, in some embodiments, an auxiliary device (e.g., any one of auxiliary devices 116A-116N) may be a user interface or front-facing computing device that a user may interact with. The auxiliary device may be configured to receive user input and may provide a service entity request in response to the received user input. For example, user input may include a user manually entering requested information (e.g., a user identifier, a user credential, and/or service entity of interest) such that the received service entity request may include this information. For example, the user identifier may be a username, user account number, bank card number, email address, and/or the like and the user credential may be a password, personal identification number (PIN), a biometric (e.g., face scan, iris scan, fingerprint scan, or the like). Additionally, the user may select a service entity of interest. For example, the auxiliary device may be configured to display one or more possible service entities and the user may interact with the auxiliary device (e.g., point, click, audibly select, etc.) the service entity of interest. The auxiliary device may then be configured to receive this information from the user and provide the service entity request to communications hardware 206 that includes this information.

In some embodiments, user input may include a user providing an associated card (e.g., a debit card, credit card, or other identification card) to the auxiliary device (e.g., any one of auxiliary devices 116A-116N), which may use the card to obtain the information. For example, the auxiliary device may be a card reader that a user can insert, swipe, or hold his/her card near such that the auxiliary device can obtain the necessary information. Optionally, in some embodiments, the user may additionally perform one or more additional actions (e.g., entering a PIN, a zip code, or other identifying information). Here, the indication of service entity identity may be indicated by the associated card number. For example, the card number may include a bank identification number (BIN) that uniquely identifies the service entity. Additionally, the card number may serve as the user identifier for the user. The additional information (e.g., PIN, zip code, or the like) may serve as the user credential.

In some embodiments, a user may use his/her user device (e.g., any one of user devices 106A-106N) to interact with the auxiliary device (e.g., any one of auxiliary devices 116A-116N). For example, the user may open up a mobile application associated with a service entity of interest using the user device and the user device may use Bluetooth, NFC, or communication methods to provide a service entity request to the auxiliary device. For example, the user may input a user identifier and user credential into the mobile application associated with a service entity and the user device may securely transmit this information (e.g., the user identifier, user credential, and particular mobile application identity) to the auxiliary device that is then configured to provide the service entity request to communications hardware 206. In this way, the user device may communicate with apparatus 200 using the auxiliary device such that one or more operations that may normally not be able to be performed solely using the digital mobile application may be performed for the user.

Alternatively, in some embodiments, the communications hardware 206 may receive the service entity request from a user device (e.g., any one of user devices 106A-106N) and an association request from auxiliary device (e.g., any one of auxiliary devices 116A-116N). In some embodiments, the service entity request may include a location (e.g., global positioning system (GPS) coordinates, relative coordinates, or the like) and/or an auxiliary device identifier for the proximate auxiliary device and the association request may include a location (e.g., GPS coordinates, relative coordinates, or the like) and a user device identifier for the user device. As such, operations management circuitry 208 may determine that the user device and auxiliary device are in communication with one another and may utilize either or both devices in subsequent operations.

As shown by operation 404, the apparatus 200 includes means, such as processor 202, memory 204, communications hardware 206, operations management circuitry 208, or the like, for determining a service entity configuration set. Once the communications hardware 206 has received the service entity request, the operations management circuitry 208 may be configured to determine a service entity configuration set for the service entity indicated by the service entity request. In some embodiments, a service entity configuration set may be stored in service entity configuration repository. The service entity configuration repository may be configured to store a service entity configuration set for each service entity associated with apparatus 200. In some embodiments, the operations management circuitry 208 may be configured to access the service entity configuration repository using communications hardware 206.

Each service entity configuration set may be identified by one or more service entity identifiers. Thus, the operations management circuitry 208 may use the indication of the service entity to determine a service entity configuration set that corresponds to the service entity of interest for the user. By way of particular example, the service entity request may include a service entity name, BIN, and/or the like and the operations management circuitry 208 may use these service entity identifiers to determine the service entity configuration set.

A service entity configuration set may store settings, parameters, templates, interfaces, documents, instructions, and/or the like for the service entity to which the service entity configuration set corresponds. Thus, the service entity configuration set may be indicative of customized and/or tailored instructions and operations that apparatus 200 may perform for the user on behalf of the service entity. In some embodiments, the service entity configuration set may include one or more service entity devices and/or endpoints that apparatus 200 may use to connect with an appropriate service entity device in order for the service entity to perform various operations for the user. Thus, the operations management circuitry 208 may be configured to determine the associated and appropriate service entity device to use to establish a session with for such operations.

In some embodiments, the service entity device is an API gateway server that may be configured to encapsulate internal service entity system architecture. In some embodiments, the service entity configuration set further comprises various API documentation for the service entity device. In some embodiments, the service entity configuration set comprises a list of available endpoints, the methods supported by each endpoint, and the expected request format and expected response format for each endpoint. The service entity configuration set may therefore provide apparatus 200 with an indication of how to format particular requests and further, where to send each request. Additionally, the service entity configuration set may provide rules or schemes on how to protect data within communications for each request. This allows for streamlined and efficient communication between apparatus 200 and the service entity device.

As shown by operation 406, the apparatus 200 includes means, such as processor 202, memory 204, communications hardware 206, operations management circuitry 208, cryptographic circuitry 212, or the like, for initiating a session with the service entity device. Once the operations management circuitry 208 determines the service entity configuration set that corresponds to the service entity indicated by the service entity request, the operations management circuitry 208 may determine the appropriate service entity device for the service entity. Additionally, the operations management circuitry 208 may use the service entity configuration set to identify an appropriate request format and an endpoint to provide a session establishment request. The communications hardware 206 may then initiate a session with the service entity device.

In some embodiments, the operations management circuitry 208 may analyze the service entity configuration set to determine a format for the session establishment request that may be used to initiate the session. The service entity configuration set may be indicative to include the user identifier and user credential in the body of the session establishment request. Thus, the service entity device may use the user identifier to identify the user the session establishment request pertains to and further, may authenticate the user using the user credential. Furthermore, the service entity configuration set may be indicative to include a particular header for the session establishment request that may signal a request to establish a session with the service entity device.

In some embodiments, the service entity configuration set may be further indicative to include a device identifier that corresponds to apparatus 200. The device identifier may be an identifier that uniquely identifies apparatus. In some embodiments, the device identifier for apparatus 200 may correspond to a serial number, an internet protocol (IP) address, a media access control (MAC) address, a server certificate, a client identifier, and/or the like. In some embodiments, the recipient service entity device may determine whether the provided device identifier corresponds to a list of authorized identifiers. In an instance the provided device identifier does correspond to a list of authorized identifiers, only then may the service entity device attempt to authenticate the user. This may ensure that apparatus 200 is an authorized computing device capable of facilitating this user interaction on behalf of the service entity.

In some embodiments, the operations management circuitry 208 may determine the service entity configuration set is indicative to protect a portion or all of the data included in the session establishment request. In particular, the service entity configuration set may include instructions for the cryptographic circuitry 212 to use either a symmetric encryption algorithm or asymmetric encryption algorithm and/or may include instructions on the specific encryption algorithm to use. In some embodiments, the service entity configuration set may further indicate the particular cryptographic key to be used with the encryption algorithm. The cryptographic circuitry 212 may then protect the data (e.g., the user identifier and/or user credential) using the defined encryption technique. The cryptographic circuitry 212 may use any suitable cryptographic technique to encrypt the data. In some embodiments, apparatus 200 and the particular service entity device may have established a shared cryptographic key (e.g., a symmetric cryptographic key) with one another. Thus, the cryptographic circuitry 212 may protect the data within the session establishment request using a symmetric encryption algorithm (e.g., an advanced encryption standard (AES) algorithm, a data encryption standard (DES) algorithm, a Blowfish algorithm, or a Rivest Cipher algorithm, such as RC4, RC5, or RC6). Alternatively, the cryptographic circuitry 212 may use a public cryptographic key of a asymmetric cryptographic key pair associated with service entity device to encrypt the data within the session establishment request using an asymmetric encryption algorithm (e.g., a Rivest-Shamiar-Adleman (RSA) algorithm).

In some embodiments, the operations management circuitry 208 may generated the session establishment request in accordance with a hypertext transfer protocol (HTTP) or HTTP secure (HTTPS) protocol with appropriate headers and body, as defined by the service entity configuration set. In some embodiments, the session establishment request may be provided using various APIs. The APIs used by communications hardware 206 may be stateless, such as representational state transfer (RESTful) APIs. For stateless APIs, the communications hardware 206 may use persistent-like techniques such that session is may be persistent or extended without the need for repeated HTTP requests. For example, techniques such as long-polling, streaming APIs, keep-alive connections, gRPC, and/or the like may be used to persist the session. For stateless APIs, the session may be identified using a session token, as described in more detail below. In some embodiments, the session establishment request may be provided using an appropriate HTTP header, such as a “POST” header or a “GET” header. The session establishment request may additionally include other HTTP headers. Additionally, the session establishment request may include the endpoint indicated by the service entity configuration set that corresponds to establishing the session. The communications hardware 206 may provide the session establishment request to the service entity device.

Alternatively, the API may be a stateful API, such as WebSocket. Stateful APIs may maintain the state or context between different requests between communications hardware 206 and the service entity device. For stateful APIs, the service entity configuration set may be indicative to first provide a request to upgrade the connection from HTTP or HTTPS to a stateless API (e.g., WebSocket). In some embodiments, the service entity configuration set may further be indicative that this requires a random value to be sent to facilitate a handshake between apparatus 200 and the service entity device. In some embodiments, the cryptographic circuitry 212 may further be configured to generate this random value, which is included as a header in the request to upgrade. The communications hardware 206 may provide the request to upgrade to the service entity device and may receive a response to the request from the service entity device. The response to the request may include a confirmation of whether the switch to the stateful API was performed and further, includes a response random value. The response random value may be a hashed value based on the random value and a globally unique identifier (GUID) (e.g., a predefined value that is part of the WebSocket protocol standard) as hashed by the service entity device. In some embodiments, the cryptographic circuitry 212 may be configured to verify the received response random value by performing the same hashing and using the same GUID. In an instance the cryptographic circuitry 212 arrives at a value that matches the received response random value, apparatus 200 may verify that the service entity device correctly understands the stateful API protocol. Once this is confirmed, the communications hardware 206 may upgrade the connection to the restful API (e.g., WebSocket). The communications hardware 206 may then provide the session establishment request through the restful API connection such that request headers may not be required.

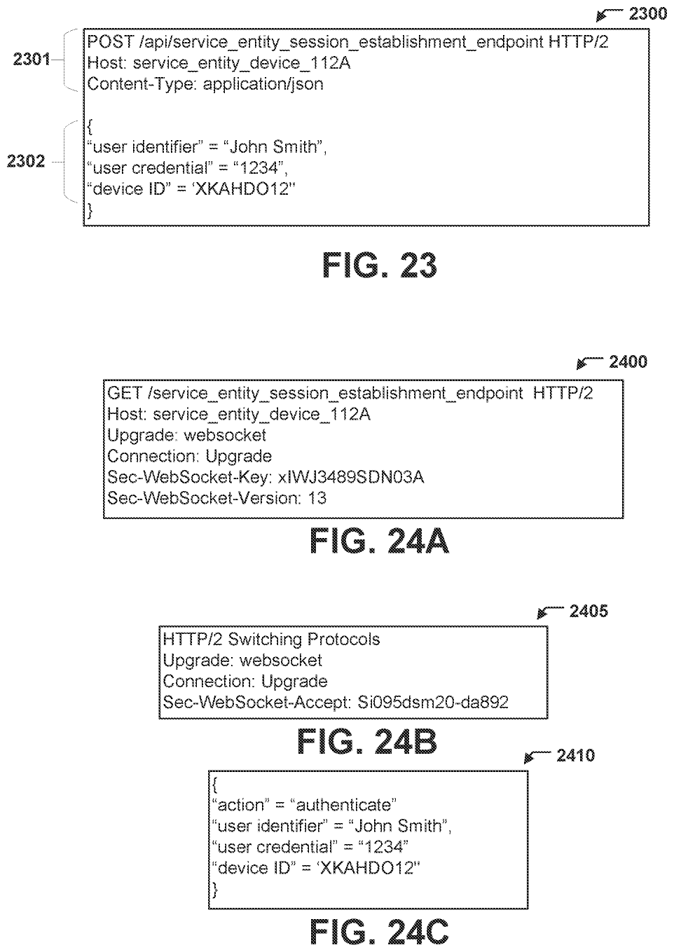

FIG. 23 depicts a first example session establishment request 2300. The session establishment request 2300 may be provided to a service entity device using a stateless API (e.g., a RESTful API). The session establishment request 2300 includes header 2301 and a body 2302. The headers 2301 may specify the type of HTTP request (e.g. “POST”), the endpoint used to establish a session (e.g., “service_entity_session_establishment_endpoint”), and the version of the HTTP protocol (e.g., “HTTP 2”). Additionally, session establishment request 2300 may include a host header that is indicative of the domain name of a recipient service entity device (e.g., “service_entity_device_112A”). The session establishment request 2300 may also include a content-type header that is indicative of the type of media within the body of the request (e.g., “application/json”). Furthermore, the session establishment request 2300 may include body content 2302. In particular, the session establishment request 2300 body may include the values for the user identifier, the user credential, and the device identifier for apparatus 200.

FIG. 24A depicts an example request 2400 to upgrade the connection from HTTP or HTTPS to a stateless API, in this case to WebSocket. The request 2400 includes the type of HTTP request (e.g., “GET”), the endpoint used to establish a session (e.g., “service_entity_session_establishment_endpoint”), and the current version of the HTTP protocol (e.g., “HTTP 2”). The request 2400 further includes the request to upgrade the connection to WebSocket as well as the random value that is used to confirm the service entity device can handle WebSocket communications (e.g., “xIWJ3489SDN03A”). The request 2400 further includes the requested version for the WebSocket API.

FIG. 24B depicts an example response 2405 to the request 2400 for an upgrade to WebSocket. The response 2405 includes an indication of whether the request was accepted and further, includes the response random value (e.g., Si095dsm20-da892). The cryptographic circuitry 212 may verify this response random value to verify that the service entity device understands WebSocket communications.

FIG. 24C depicts a second example session establishment request 2410. The session establishment request 2410 may be provided to a service entity device using a WebSocket message. The session establishment request 2410 may include the values for the user identifier, the user credential, and the device identifier for apparatus 200. Because session establishment request 2410 is a WebSocket communication, session establishment request 2410 may not need headers.

Returning now to FIG. 4, as shown by operation 408, the apparatus 200 includes means, such as processor 202, memory 204, communications hardware 206, or the like, for receiving a session establishment response. Once the communications hardware 206 has provided the session establishment request, the recipient service entity device may perform various operations on the session establishment request, as discussed in further detail in FIG. 12. In an instance in which the service entity device successfully authenticates a user to which the session establishment request pertains, the communications hardware 206 receives a session establishment response. The session establishment response includes a session token that may be used to identify the particular session between communications hardware 206 and the service entity device and user account data pertaining to a user account for the user. The session token may be stored in an associated memory, such as memory 204.

The user account data may include any user account data associated with the user account managed by the service entity. By way of particular example, the service entity may be a financial institution and the user account data may include a user personal data (e.g., name, address, phone number, email, date of birth, identification number, and/or the like), user account details (e.g., user account type, user account number, status of user account, a date of the user account opening, a date of the user account closing), an associated transaction history, user account balances, scheduled transactions, current available financial product offers, safe deposit box information, credit information (e.g., credit lines, credit limits, credit history), loan information (e.g., loan amount, loan repayment schedule, interest rates, payment history, outstanding balance), user account security information (e.g., fraud alerts, security questions, unusual activity flags, or the like), and/or the like.

In some embodiments, a user may have multiple user accounts with a particular service entity. In such an instance, the session establishment response may include user account data pertaining to all user accounts of the user that are managed by the service entity. By way of continuing example, the service entity may be a financial institution and the user may have a checking user account and a savings user account. If a user may have only provided an indication of one of these user accounts (e.g., provided a debit card corresponding to the checking user account), the service entity device may determine the user is also associated with the savings user account and may provide user account data in the session establishment response for the savings user account as well.

In some embodiments, data within the session establishment response may be encrypted such that cryptographic circuitry 212 may be required to decrypt the data. In particular, the user account data and optionally, the session token may be encrypted. The cryptographic circuitry 212 may decrypt the encrypted data using a corresponding decryption algorithm. In some embodiments, the service entity configuration set may include instructions for the cryptographic circuitry 212 to use a specific decryption algorithm. In some embodiments, the service entity configuration set may further indicate the particular cryptographic key to be used with the decryption algorithm. For example, the service entity configuration set may specify that the encrypted data was encrypted using an asymmetric encryption algorithm such that the cryptographic circuitry 212 may use a private key of an asymmetric cryptographic key pair associated with apparatus 200 to decrypt the encrypted data. Alternatively, the service entity configuration set may specify that the encrypted data was encrypted using a symmetric encryption algorithm such that the cryptographic circuitry 212 may use a symmetric key shared between apparatus 200 and the service entity device to decrypt the encrypted data.

In some embodiments, the communications hardware 206 may receive the session establishment response from the service entity device using a HTTP or HTTPS protocols and/or corresponding APIs. The format of the session establishment response may depend on whether a restless or restful API was use for the session establishment request. The service entity configuration set may be indicative of the format for the session establishment response.

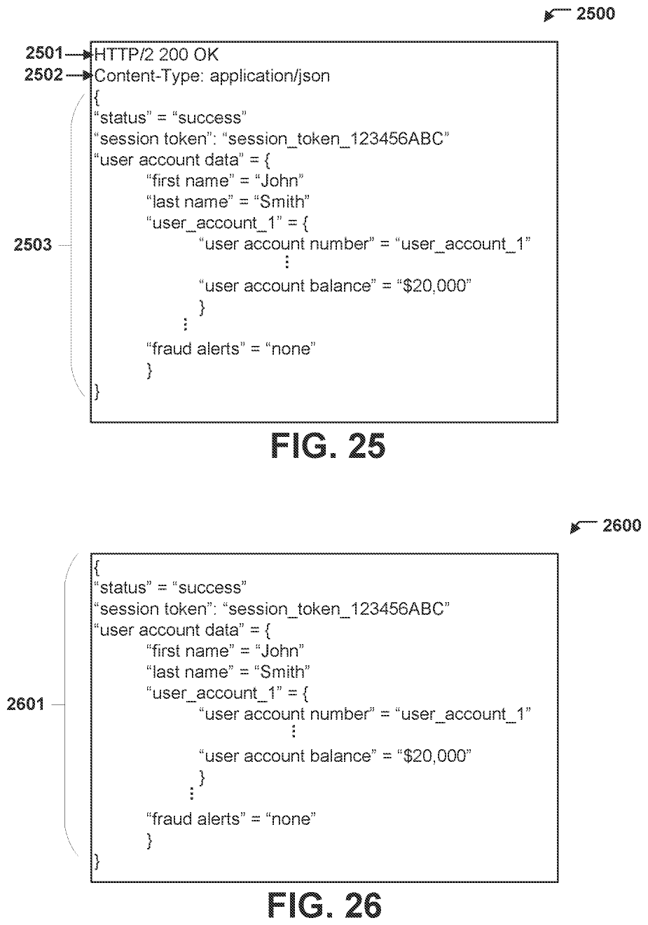

FIG. 25 depicts an example session establishment response 2500 received from the service entity device through a stateless API. The response 2500 may include a status line 2501 indicative of whether the request was successful and a content-type header 2502 indicative of the body format. The response 2500 may further include the body 2503 that includes an indication of whether the request was successful, the session token, and the user account data.

FIG. 26 depicts an example session establishment response 2600 received from the service entity device through a stateful API. The response 2600 may include a body 2601 that provides an indication of whether the request was successful, the session token, and the user account data.

Returning now to FIG. 4, as shown by operation 410, the apparatus 200 includes means, such as processor 202, memory 204, interface circuitry 210, or the like, for generating service entity user interface data. Once the user account data is received in the session establishment response and decrypted, the interface circuitry 210 may generate service entity user interface data based on the user account data and the service entity configuration set. The service entity configuration set may include instructions for generating user interface templates for various user interfaces to be provided to the user. For example, the service entity configuration set may include a homepage user interface template.

In some embodiments, each user interface template may be associated with an operation flow. For example, a homepage user interface template may be associated with a first position within the operation flow. The homepage user interface template may include one or more operation request interface elements that the user may interact with (e.g., click, touch, audibly select, or the like) to request a particular operation. Each operation request interface element may be associated with a particular next user interface template such that in an instance that the user clicks on an interface element from the homepage user interface, a next user interface associated with the requested operation may be provided. This operation flow may continue until a stopping point is reached (e., a point at which an operation request may be received by the communications hardware 206). Thus, in some embodiments the service entity user interface data may include multiple user interface templates up to a stopping point.

Each user interface template may have static objects and dynamic objects. A static object may be an unchanging value between various users such that the interface circuitry 210 does not need to modify or update the static object. A dynamic object may be a value that varies between users, such as a value that depends on user account information, such that interface circuitry 210 needs to modify the dynamic object with the user account data. Each static object and dynamic object may be associated with an object type. For example, static object types may include a service entity logo, a particular operation request interface element, and/or the like. A dynamic object type may include a user name, user account type, user account balance, and/or other user account specific data.

To determine a value for dynamic object, the interface circuitry 210 may identify the dynamic object type and may further identify a value from the user account data that corresponds to the dynamic object type. In some embodiments, the session establishment response may be structured such that each user account value of user account data is assigned a user account data type. The dynamic object type may correspond to a particular user account data type such that the interface circuitry 210 may identify a corresponding user account value for the user account data type and may update the dynamic object accordingly.

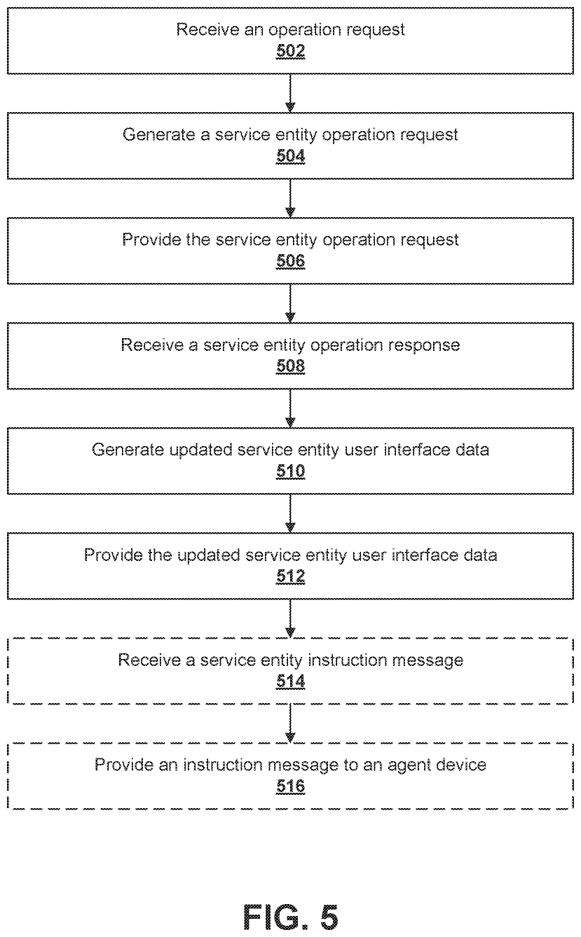

As described above, a static object type may include a particular operation request interface element. In some embodiments, the service entity configuration set may include an indication of each operation type or service type that the service entity may perform for a user and/or user account. For example, the service entity configuration set may describe that the service entity offers services types that include user account services (e.g., opening a new user account, closing a user account, managing a user account), fund withdrawals from a user account, fund deposits to a user account, loan services, advisement services, safe deposit box management, currency exchange services, card services (e.g., issuing service entity cards, assistance with stolen service entity cards, setting PINs, managing card feature, or the like), notary services, verification services, wire transfer services, payment services (e.g., managing or enrolling in auto-pay), resolving user account disputes, educational services, handling security or fraud inquiries, and/or the like. The operations or services offered by the service entity may differ from other service entities. Thus, the interface circuitry 210 may use the service entity configuration set to determine exactly which services the service entity offers. An interface template within the service entity configuration set may include one or more interface elements that correspond to a particular offered service. In an instance in which a user interacts with the interface element for a service, this may cause a recipient auxiliary device to provide communications hardware 206 with an operation request, as described in more detail in FIG. 5.

The interface circuitry 210 may generate the service entity user interface data in a standardized format (e.g., JavaScript Object Notation (JSON), Extensible Markup Language (XML), hypertext markup language (HTML), an image, and/or the like). Additionally, the interface circuitry 210 may generate software executable instructions that may cause a recipient computing device to render the service entity user interface data on an associated display.

As shown by operation 412, the apparatus 200 includes means, such as processor 202, memory 204, communications hardware 206, or the like, for providing the service entity user interface data. Once the interface circuitry 210 has generated the service entity user interface data, the communications hardware 206 may provide the service entity user interface data to an auxiliary device (e.g., any one of auxiliary devices 116A-116N). In some embodiments, the service entity user interface data is provided to the same auxiliary device that provided the service entity request. Alternatively, the service entity user interface data is provided to a different auxiliary device than the auxiliary device that provided the service entity request.

Upon receipt of the service entity user interface data, the recipient auxiliary device may be caused to render the service entity user interface data on an associated display. In some embodiments, the user may interact with the service entity user interface data using the recipient auxiliary device, a different recipient auxiliary device, or via a user device (e.g., any one of user devices 106A-106N).

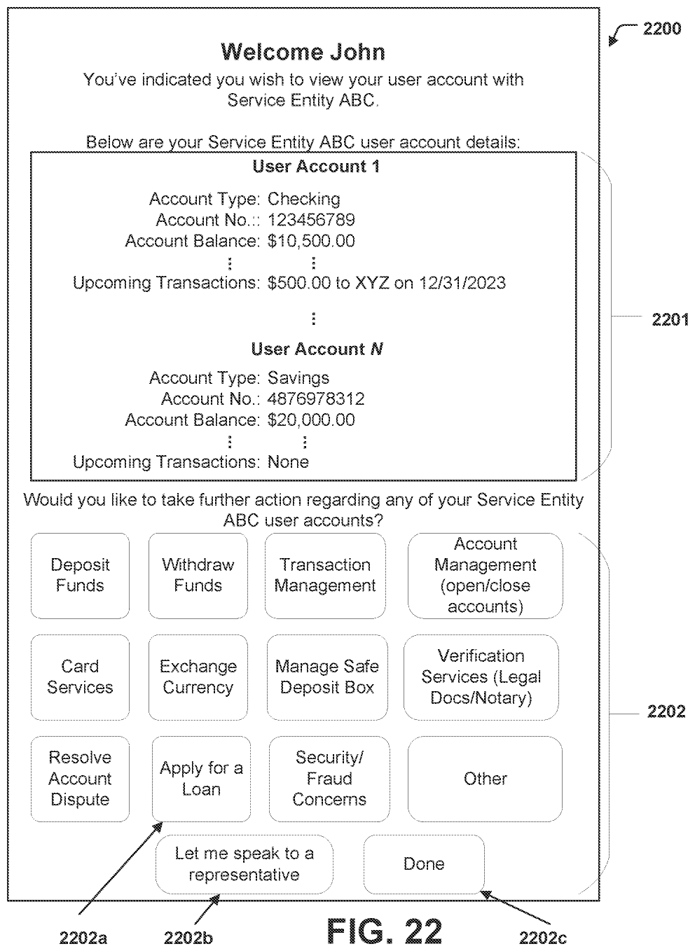

Turning to FIG. 22, a graphical user interface (GUI) is provided that illustrates an example service user interface data GUI 2200. A user may interact with the operation management system 102 using a separate auxiliary device (e.g., any of auxiliary devices 116A-116N, as shown in FIG. 1), which may communicate with the operation management system 102 via trusted communications network 105. In some embodiments, the user may interact with the auxiliary device (e.g., any of auxiliary devices 116A-116N) and/or the operation management system 102 using a separate user device (e.g., any one of user devices 106A-106N, as shown in FIG. 1). In particular, in some embodiments, an auxiliary device provided with the service entity user interface data may provide the service entity user interface data to a user device within proximity of the auxiliary device such that the user may use his/her user device to view and/or interact with the service entity user interface data. Thus, the GUI shown in FIG. 22 may be displayed to the user by the auxiliary device, a display associated with the auxiliary device, and/or a user device.

FIG. 22 depicts the example service user interface data GUI 2200. As shown in FIG. 22, the service user interface data GUI 2200, may include various user account data 2201. Each user account data value of the user account data 2201 may be a formatted dynamic object from a corresponding interface template. Thus, the user may be presented with an overview of the various user accounts that are managed by the service entity. The service user interface data GUI 2200 may also include one or more interface elements 2202. Each interface element 2202 may be a formatted static objected from a corresponding interface template. A user may interact with an interface element to request a particular service. For example, the user may interact with interface element 2202a to request to apply for a loan. In some embodiments, interaction with an interface element may cause an additional interface to be rendered and/or additional prompts to be rendered to get further user input to facilitate a requested service corresponding to a service request type. In some embodiments, the service user interface data may contain the data necessary to render the additional interface and/or prompts. Alternatively, the auxiliary device that received the service user interface data may request additional data from the communications hardware 206 to facilitate the request. Once the user has provided the necessary input for a service request of a service request type, this may cause the auxiliary device to generate an operation request that is provided to communications hardware 206.

Turning now to FIG. 5, example operations are shown for facilitating an operation request for a user with the service entity. Once a service entity user interface data GUI has been displayed to the user (e.g., using an auxiliary device and/or user device), the user may interact with the service entity user interface data GUI to request a particular service and the communications hardware 206 may receive a corresponding operation request. Apparatus 200 may then structure and provide a service entity operation request to the service entity device using the established session to facilitate the requested service for the user and/or user account. The service entity device may then cause performance of operations for the requested service.

As shown by operation 502, the apparatus 200 includes means, such as processor 202, memory 204, communications hardware 206, or the like, for receiving an operation request. In some embodiments, the communications hardware 206 may receive an operation request from an auxiliary device. The operation request may pertain to the user and may be indicative of a request for the service entity to perform an operation related to the user account. In particular, the operation request may be indicative of the service request type.

In some embodiments, the operation request may further be indicative of one or more service request parameters that correspond to the service request of the service request type. The particular service request parameters may be based on the service request type. For example, if the service request type is “deposit funds” service request type, the service request parameters may further specify the amount of funds to deposit and the user account to deposit the funds. As another example, if the service request type is a “new user account” service request type, the service request parameters may further specify the type of user account requested to be opened.

As described above, the provided service entity user interface data may include one or more interface elements that correspond to a particular offered service. In an instance in which a user interacts with the interface element for a service, this may cause a recipient auxiliary device to provide communications hardware 206 with an operation request that includes an indication of the service type for the operation request and associated request parameters.

As shown by operation 504, the apparatus 200 includes means, such as processor 202, memory 204, operations management circuitry 208, cryptographic circuitry 212, or the like, for generating a service entity operation request. The operations management circuitry 208 may generate a service entity operation request that includes the session token that was received in the session establishment response in operation 408 of FIG. 4. The session token may be used by the service entity device to identify the session such that the service entity device may determine the user has already been authenticated, identify apparatus 200 has already been determined to be an authenticated device, and/or identify the user accounts associated with the session. Additionally, inclusion of the session token provides a mechanism to allow participating devices using stateless APIs to facilitate the session to identify the necessary information needed to process the service entity operation request despite each request communication being a separate, stateless interaction.

Additionally, the operations management circuitry 208 may include the service request type and one or more service request parameters from the operation request, in the service entity operation request. In some embodiments, operations management circuitry 208 may generate the service entity operation request that is specific to a service request type. For example, the operations management circuitry 208 may include a header that corresponds to the service request type and the body of the service entity operation request may include the service request parameters. In some embodiments, the operations management circuitry 208 may use the service entity configuration set to determine the appropriate header and format of the body for the service entity operation request. By defining the particular structure of the operation request, the recipient service entity device is able to immediately identify the service request type without expending additional computational resources. This allows for a streamlined and efficient communication process, whereby the recipient service entity device may be capable of facilitating operations for the requested service in real-time or near real-time, thereby paralleling a user experience indistinguishable from a user experience using a conventional service entity specific system.

In some embodiments, prior to generating the service entity operation request, the communications hardware 206 may wait on additional authorization from an auxiliary device (e.g., any one of authorization devices 116A-116N). In particular, for certain service request types, the user may need to first perform an operation to facilitate the service request. By way of particular example, the user must first provide the funds to an agent and/or auxiliary device before the operations management circuitry 208 can generate a service entity operation request for a “deposit funds” service request type. The operations management circuitry 208 may use the service entity configuration set to determine whether additional authorization is required prior to generating the service entity operation request. The communications hardware 206 may receive the additional authorization from an auxiliary device (e.g., in response to an in-person agent or automatically from a self-sufficient auxiliary device).

In some embodiments, the operations management circuitry 208 may format the service entity operation request in accordance with a HTTP protocol or HTTPS protocol. In particular, the service entity operation request may include one or more headers and body. A first HTTP header may be an authorization header and may contain the value of the session token. A second HTTP header may be a content-type header that is indicative of the format of the data in the body. The body may of the service entity operation request may include an indication of the service request type and the service request parameters. In some embodiments, the operations management circuitry 208 may use the service entity configuration set to determine an endpoint that is configured to support the particular service request type. Alternatively, in an instance a restful API is used, the body of the service entity operation request may include the service request type.

In some embodiments, the cryptographic circuitry 212 may encrypt all or some of the data (e.g., the session token, service request type, service request parameters, or the like) within the service entity operation request prior to providing the service entity operation request. The cryptographic circuitry 212 may use any suitable cryptographic technique to encrypt the data. In particular, the service entity configuration set may include instructions for the cryptographic circuitry 212 to use either a symmetric encryption algorithm or asymmetric encryption algorithm and/or may include instructions on the specific encryption algorithm to use. The cryptographic circuitry 212 may encrypt this data in a substantially similar manner as the encryption of data in the session establishment request as described in operation 406 of FIG. 4.

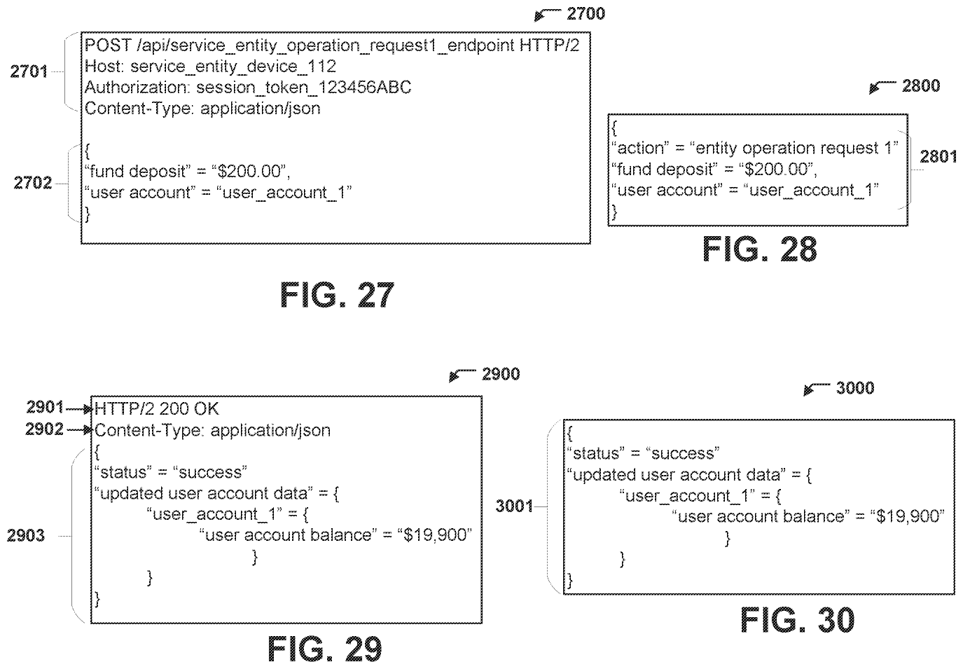

FIG. 27 depicts a first example service entity operation request 2700. The service entity operation request 2700 may be provided to a service entity device using a stateless API (e.g., a RESTful API). The service entity operation request 2700 includes headers 2701 and a body 2702. The headers 2701 may specify the type of HTTP request (e.g. “POST”), the endpoint used to establish a session (e.g., “service_entity_operation_request1_endpoint”), and the version of the HTTP protocol (e.g., “HTTP 2”). Additionally, service entity operation request 2700 may include a host header that is indicative of the domain name of a recipient service entity device (e.g., “service_entity_device_112A”). The service entity operation request 2700 may also include an authorization header that contains the value of the session token (e.g., “session_token_123456ABC”). The service entity operation request 2700 may also include a content-type header that is indicative of the type of media within the body of the request (e.g., “application/json”). Furthermore, the service entity operation request 2700 may include body content 2702. In particular, the service entity operation request 2700 body may include the values for service request parameters. In this example, the service request type may correspond to a “deposit funds” service request type and the service request parameters may include an amount of funds to deposit and a user account to deposit the funds.

FIG. 28 depicts a second example service entity operation request 2800. The service entity operation request 2800 may be provided to a service entity device using a stateful API (e.g., WebSocket). In this example, because the API is a stateful API, the service entity operation request 2800 may include the values for service request parameters (e.g., the amount of funds to deposit and a user account to deposit the funds).

Returning now to FIG. 5, as shown by operation 506, the apparatus 200 includes means, such as processor 202, memory 204, communications hardware 206, or the like, for providing the service entity operation request. Once the operations management circuitry 208 has generated the service entity operation request, the communications hardware 206 may provide the service entity operation request to the corresponding service entity device. As described above, the communications hardware 206 may provide the service entity operation request using the established session and using the corresponding APIs.

As shown by operation 508, the apparatus 200 includes means, such as processor 202, memory 204, communications hardware 206, or the like, for receiving a service entity operation response. The communications hardware 206 may receive a service entity operation response from the service entity device. The service entity operation response may be indicative of whether an operational flow corresponding to the service request type was successfully performed. In an instance the operational flow was successfully performed, this may indicate the service entity device performed operations associated with the service request type for the user and/or user device. The service entity operation response may further include updated user account data. The updated user account data may reflect changes to a user account made in response to performance of the operational flow for the service request type.

For example, the service entity operation request may have indicated a “withdraw funds” service request type for an amount of $100. Thus, the service entity device may have performed an operation to subtract the amount of $100 from the requested user account in response to the withdrawal. The updated user account data may reflect an updated user account balance after the withdrawal (e.g., $100 less than the original user account balance).

In some embodiments, data within the service entity operation response may be encrypted such that cryptographic circuitry 212 may be required to decrypt the data. In particular, the updated user account data may be encrypted. The cryptographic circuitry 212 may decrypt the encrypted data using a corresponding decryption algorithm. In some embodiments, the service entity configuration set may include instructions for the cryptographic circuitry 212 to use a specific decryption algorithm. In some embodiments, the service entity configuration set may further indicate the particular cryptographic key to be used with the decryption algorithm. For example, the service entity configuration set may specify that the encrypted data was encrypted using an asymmetric encryption algorithm such that the cryptographic circuitry 212 may use a private key of an asymmetric cryptographic key pair associated with apparatus 200 to decrypt the encrypted data. Alternatively, the service entity configuration set may specify that the encrypted data was encrypted using a symmetric encryption algorithm such that the cryptographic circuitry 212 may use a symmetric key shared between apparatus 200 and the service entity device to decrypt the encrypted data.

FIG. 29 depicts a first example service entity operation response 2900 received from the service entity device through a stateless API. The service entity operation response 2900 may include a status line 2901 indicative of whether the request was successful and a content-type header 2902 indicative of the body format. The service entity operation response 2900 may further include the body 2903 that includes an indication of whether the operational flow for the service request type was successfully performed and updated user account data.

FIG. 30 depicts a second example service entity operation response 3000 received from the service entity device through a stateful API. The service entity operation response 3000 includes an indication of whether the operational flow for the service request type was successfully performed and updated user account data.

Returning now to FIG. 5, as shown by operation 510, the apparatus 200 includes means, such as processor 202, memory 204, interface circuitry 210, or the like, for generating updated service entity user interface data. In an instance in which the service entity device successfully performs the operational flow for the service request type and provides updates user account data in the service entity operation response, the interface circuitry 210 may generate updated service entity user interface data. The interface circuitry 210 may generate updated service entity user interface data based on the updated user account data and the service entity configuration set. The interface circuitry 210 may generate the updated service entity user interface data in a substantially similar manner to operation 410 of FIG. 4.

As shown by operation 512, the apparatus 200 includes means, such as processor 202, memory 204, communications hardware 206, or the like, for providing the updated service entity user interface data. Once the interface circuitry 210 has generated the updated service entity user interface data, the communications hardware 206 may provide the updated service entity user interface data to an auxiliary device (e.g., any one of auxiliary devices 116A-116N). In some embodiments, the updated service entity user interface data is provided to the same auxiliary device that provided the service entity request and/or operation request. Alternatively, the updated service entity user interface data is provided to a different auxiliary device than the auxiliary device that provided the service entity request and/or operation request. The communications hardware 206 may provide the updated service entity user interface data in a substantially similar manner to operation 412 of FIG. 4.

Upon receipt of the updated service entity user interface data, the recipient auxiliary device may be caused to render the updated service entity user interface data on an associated display. In some embodiments, the user may interact with the service entity user interface data using the recipient auxiliary device, a different recipient auxiliary device, or via a user device (e.g., any one of user devices 106A-106N). As such, the user may view his/her updated user account data and information. Additionally, the user may interact with a service user interface data GUI that includes the updated service entity user interface data to provide additional operation requests such that apparatus 200 may perform the operations described in FIG. 5 to facilitate a new service request corresponding to a service request type.

Optionally, as shown by operation 514, the apparatus 200 includes means, such as processor 202, memory 204, communications hardware 206, or the like, for receiving a service entity instruction message. The service entity instruction message may include one or more instructions to perform an interaction with the user. The interaction with the user may be necessary to facilitate the requested service. By way continuing example, the service entity operation request may have indicated a “withdraw funds” service request type for an amount of $100. Thus, the user needs to receive funds in the amount of $100 from an agent and/or auxiliary device to facilitate the full service request. In some embodiments, the interaction with the user may include providing the user with a currency amount, receiving a currency amount from the user, providing the user with a document corresponding to a document type, or receiving a document corresponding to a document type from the user.

In some embodiments, the entity instruction message may include one or more documents that pertain to the service request type. For example, the service request type may be for a loan application. Thus, the entity instruction message may include the loan application for the service entity. Alternatively, the service entity configuration set may include documents of various document types.

Optionally, as shown by operation 516, the apparatus 200 includes means, such as processor 202, memory 204, communications hardware 206, operations management circuitry 208, or the like, for providing an instruction message to an agent device. In some embodiments, the operations management circuitry 208 may be configured to generate an instruction message that is provided to an agent device. The instructions may be indicative for an agent and/or an agent device to perform the user interaction.

In some embodiments, the agent device may be associated with a live agent. Thus the instructions may cause a message or prompt describing the user interaction to render on the agent device. For example, the instruction message may indicate that the agent is to provide the user with funds in the amount of $100.00. Additionally, the operations management circuitry 208 may generate additional instruction messages to provide to the same or a different agent device. In some embodiments, the instructions may include software executable instructions that cause the recipient agent device to automatically perform one or more actions. By way of continuing example, an agent device may be a cash register, teller cash dispenser (TCD), or a teller cash recycler (TCR) and the instruction message may include software executable instructions that cause the agent device to dispense funds or receive funds of a particular amount. These agent devices may each be associated with an agent device balance amount that may be an amount stored and maintained by the operation management system 102. Instructions that indicate a change in funds for an agent device may cause an update to the agent device balance.

In some embodiments, the agent device may be associated with a virtual agent. Thus the instructions may be software executable instructions that automatically cause the agent device to perform the action. For example, the instruction message may cause the agent device to provide a particular document to the user. The agent device may then process the instructions, select the appropriate document to provide to the user, and automatically provide the document to the user (e.g., a physical copy of the document or a digital copy of the document sent to a user's user device via a communication channel).

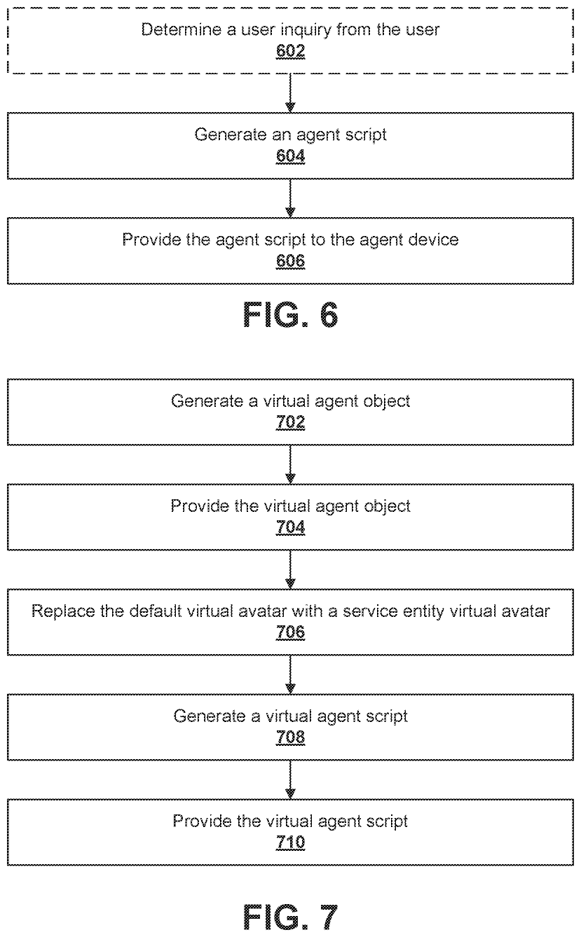

Turning now to FIG. 6, example operations are shown for providing an agent script to an agent. An agent may be a real, in-person agent that may interact with the user during his/her visit to the physical branch associated with apparatus 200. The agent may interact with the user to facilitate operations and/or service requests between the user and multiple service entities. Each service entity may have their own policies and/or procedures that the agent may be required to convey to the user during the user's visit to the physical branch. Thus, it may be advantageous to provide the agent with an agent script that indicates what information the user should convey to the user in a manner that is compliant with the policies and/or procedures of a given service entity. This may avoid miscommunications with the user and reduce user friction.

Optionally, as shown by operation 602, the apparatus 200 includes means, such as processor 202, memory 204, communications hardware 206, operations management circuitry 208, or the like, determining a user inquiry from the user. In some embodiments, a user may provide an inquiry to the agent and/or an auxiliary device (e.g., any one of auxiliary devices 112A-112N). This user inquiry may be an audible inquiry (e.g., the user verbally asks a question), a digital text inquiry (e.g., the user provides a digital text inquiry to an auxiliary device), a categorical inquiry (e.g., the user interacts with an interface element displayed on an auxiliary device that causes a categorical inquiry to be received by communications hardware 206), and/or the like.

In some embodiments, an auxiliary device may be a recording device that is configured to capture user and/or agent speech and may provide this captured audio to communications hardware 206. The operations management circuitry 208 may process the received recording using an inquiry detection model. The inquiry detection model may be trained to convert the captured audio to a text transcript, such as by using a speech-to-text (STT) function. The inquiry detection model may further be configured to analyze the resulting transcript and detect whether the user has provided an inquiry. In some embodiments, the inquiry detection model may be configured to analyze the captured in addition to the transcript. In some embodiments, the inquiry detection model may be a trained large language model (LLM) or other machine learning model that is trained to identify user inquiries from transcripts. In some embodiments, the inquiry detection model may be trained to detect particular phrases, key-terms, and/or the like from the transcript that may indicate a user inquiry. In some embodiments, the inquiry detection model may be trained to analyze audio characteristics of the audio file, such as inflection, to detect whether a user inquiry is present. The inquiry detection model may then identify the text that corresponds to the timestamp of the audio portion determined to have a user inquiry and identify the particular user inquiry from the corresponding transcript text.

Once a user inquiry is detected, from the inquiry detection model or based on a received digital text inquiry or categorical inquiry (e.g., receipt of these inquiries may be sufficient to detect an inquiry such that additional processing to determine whether an inquiry is detected may be unnecessary), the operations management circuitry 208 may determine a user inquiry type that corresponds to the user inquiry. In some embodiments, the operations management circuitry 208 may use an inquiry categorization machine learning model to determine the user inquiry type based on the user inquiry. The inquiry categorization machine learning model may be a trained machine learning model that is configured to analyze the text of a user inquiry and determine a user inquiry type from a set of predefined user inquiry types. Each user inquiry type may be associated with key phrases, terms, and/or the like. The inquiry categorization machine learning model may analyze the user inquiry, which may include one or more words or sentences, to determine a similarity score for the user inquiry and one or more candidate user inquiry types. The similarity score may be an inferred likelihood of the probability that the user inquiry corresponds to a user inquiry type. The inquiry categorization machine learning model may then determine the user inquiry type based on the associated similarity score. In particular, the inquiry categorization machine learning model may select the user inquiry type that is associated with the optimal similarity score. Thus, the operations management circuitry 208 may determine a user inquiry that corresponds to a user inquiry type.

As shown by operation 604, the apparatus 200 includes means, such as processor 202, memory 204, operations management circuitry 208, or the like, generating an agent script. The operations management circuitry 208 may be configured to generate an agent script for an agent. In some embodiments, the operations management circuitry 208 may use a script generation machine learning model to generate the agent script. Additionally, in some embodiments, the operations management circuitry 208 may generate the agent script based on a user inquiry and based on a service entity configuration set associated with the service entity of interest for the user.

The script generation machine learning model may be a machine learning model that is configured with natural language processing (NLP) techniques and/or predefined rules for one or more service entities. In some embodiments, the script generation machine learning model may be an LLM. The script generation machine learning model may be configured to generate a script for the agent using an initial rule set and service entity rule set. An initial rule set may be used prior to a service entity of interest being indicated by the user. For example, when the user walks into the physical branch but has not yet provided a service entity request, the initial rule set may be used. The initial rule set may include standard greeting and/or conversational language that is non-specific to a particular service entity. For example, the initial rule set may indicate the agent should greet the user and the greeting may be specific to the time and/or date of the user visit (e.g., “good morning”, “good evening”, “happy holidays”, or the like). Once the user has provided a service entity request and a service entity of interest has been identified, the script generation machine learning model may use the service entity rule set to generate the agent script. The service entity rule set may be included in the service entity configuration set. The service entity rule set may provide instructions on the policies and/or procedures that the service entity adheres to. Additionally, the user entity rule set may have predefined answers or scripts for each user inquiry type. Thus, in an instance in which the user provides a user inquiry corresponding to a user inquiry type, the script generation machine learning model may use these predefined scripts as a basis and may apply more specific information based on the received user account data and/or apparatus 200 data (e.g., time, date, location, operating hours, or the like).

As shown by operation 606, the apparatus 200 includes means, such as processor 202, memory 204, communications hardware 206, or the like, providing the agent script to the agent device. The communications hardware 206 may provide the agent script to an agent device (e.g., any one of agent devices 108A-108N). Upon receipt of the agent script, the agent device may be configured to render the agent script on an associated display such that the agent user may use the displayed agent script to interact with the user.

It will be appreciated that operation 604-606 may be performed simultaneously. For example, operations management circuitry 208 may be configured to generate an agent script and the communications hardware 206 may be configured to provide the agent script simultaneously such that the agent is provided with the agent script in real-time. Additionally, the operations management circuitry 208 may be configured to continuously update the agent script such that the text within the agent script is responsive to the current communication with the user.

Turning now to FIG. 7, example operations are shown for providing a virtual agent. In some embodiments, an agent may be a virtual agent that may interact with the user during his/her visit to the physical branch associated with apparatus 200. The virtual agent may interact with the user to facilitate operations and/or service requests between the user and multiple service entities, similarly to how a real agent would. In some embodiments, a virtual avatar of the virtual agent may be rendered and the appearance of the virtual avatar may mimic the appearance of agents associated with a corresponding service entity. This may help instill confidence in the user that he/she is interacting with the appropriate service entity.

As shown by operation 702, the apparatus 200 includes means, such as processor 202, memory 204, operations management circuitry 208, or the like, generating a virtual agent object. In some embodiments, the operations management circuitry 208 may be configured to generate a virtual agent object. The virtual agent object may include a virtual avatar that is a virtual representation of an agent. Initially, the he virtual agent may be a default virtual avatar with an appearance that is non-specific to any particular service entity. In some embodiments, the default virtual avatar may be stored in an associated memory, such as memory 204, such that the operations management circuitry 208 may access the associated memory to retrieve the default virtual avatar and include it in the virtual agent object.

The virtual avatar may be structured in any suitable format, including as a text-based icon, a two-dimensional animated model, a three-dimensional animated model, and/or the like. The associated memory may include one or more formats for the default virtual avatar. In some embodiments, the format of the virtual avatar may be dependent upon the capabilities and/or functionalities of the auxiliary devices included in the physical location. For example, in an instance that the auxiliary device is capable of rendering a three-dimensional virtual avatar, the operations management circuitry 208 may select the three-dimensional animated model. The capabilities and functionalities of the auxiliary devices may be stored in an associated memory, such as memory 204, such that the operations management circuitry 208 may select an auxiliary device to provide the virtual agent object to.

As shown by operation 704, the apparatus 200 includes means, such as processor 202, memory 204, communications hardware 206, or the like, providing the virtual agent object. The communications hardware 206 may be configured to provide the virtual agent object to a corresponding auxiliary device (e.g., any one of auxiliary devices 116A-116N). The communications hardware 206 may provide the virtual agent object to the auxiliary device that was selected by the operations management circuitry 208. The virtual agent object may also include instructions for the recipient auxiliary device to render the virtual avatar included in the virtual agent object upon receipt of the virtual agent object. Thus, the auxiliary device may render the default virtual avatar such that the user may view the virtual agent avatar.

As shown by operation 706, the apparatus 200 includes means, such as processor 202, memory 204, communications hardware 206, operations management circuitry 208, or the like, replacing the default virtual avatar with a service entity virtual avatar. Once the user has provided a service entity request and a service entity of interest has been identified, the operations management circuitry 208 may update the virtual agent object with a service entity virtual avatar that is associated with the service entity of interest. In some embodiments, the service entity configuration set may store service entity virtual avatars in various formats. The operations management circuitry 208 may then select the service entity virtual avatar corresponding to the same format as the default virtual avatar. The service entity virtual avatar may configured with an appearance of an agent for the specific service entity. For example, the service entity virtual avatar may include clothing that is part of a uniform of the service entity, corresponds to an associated service color, include a service entity logo, and/or the like. Additionally, the service entity virtual avatar may be a representation of a mascot for the service entity.

The communications hardware 206 may then provide the updated virtual agent object that includes the service entity virtual avatar to the auxiliary device that was provided with the initial virtual agent object. The updated virtual agent object may include instructions for the recipient auxiliary device to replace the default virtual avatar with the service entity virtual avatar. Thus, the auxiliary device may render the service entity virtual avatar such that the user may view a virtual agent avatar that has an appearance of being associated with the service entity.

As shown by operation 708, the apparatus 200 includes means, such as processor 202, memory 204, operations management circuitry 208, or the like, generating a virtual agent script. The operations management circuitry 208 may also be configured to generate a virtual agent script for the virtual agent object. In some embodiments, the operations management circuitry 208 may use a script generation machine learning model to generate the virtual agent script. Additionally, in some embodiments, the operations management circuitry 208 may generate the virtual agent script based on a user inquiry and based on a service entity configuration set associated with the service entity of interest for the user. In some embodiments, this operation may be performed in a similar manner as operation 604 of FIG. 6.

As shown by operation 710, the apparatus 200 includes means, such as processor 202, memory 204, communications hardware 206, or the like, providing the virtual agent script. The communications hardware 206 may provide the agent script to an auxiliary device (e.g., any one of auxiliary devices 116A-116N). This auxiliary device provided with the virtual agent script may be the same auxiliary device that was provided the virtual agent object or may be a different auxiliary device. The recipient auxiliary device may be configured with a vocal model that uses text-to-speech (TTS) function to process the virtual agent script and render audio. Thus, the virtual agent script may be used in conjunction with the virtual agent object to provide the user with a visual and auditory experience that simulates the experience with a real agent.

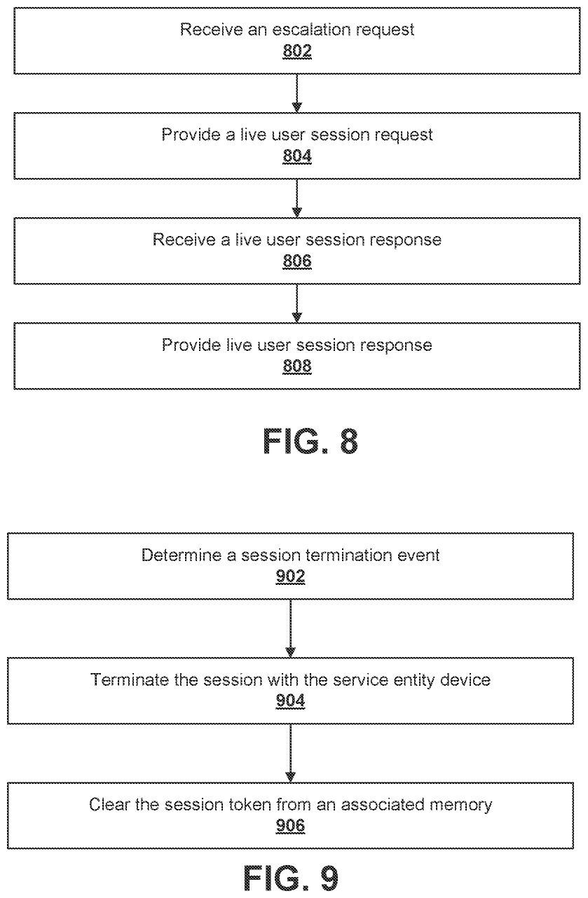

Turning now to FIG. 8, example operations are shown for handling an escalation request received from the user. In some examples, a user may request to talk to a service entity representative that is directly associated with the service entity (e.g., an employee). Additionally, for some service request types, a service entity representative may be required. Thus, in some embodiments, apparatus 200 may additionally facilitate a live user session with a service entity representative for the user.

As shown by operation 802, the apparatus 200 includes means, such as processor 202, memory 204, communications hardware 206, operations management circuitry 208, or the like, receiving an escalation request. In some embodiments, the communications hardware 206 may receive an escalation request from an auxiliary device (e.g., any one of auxiliary devices 116A-116N) that a user may interact with. In some embodiments, the user may specifically provide input to the auxiliary device to speak to a representative of the service entity. Alternatively, certain service request types may require that a user interact with a service entity representative in a live user session such that the operations management circuitry 208 may automatically determine the escalation request. The escalation request may be indicative of a request to connect to a representative associated with the service entity. In some embodiments, in an instance in which a service request type triggered the escalation request, the escalation request may further comprise the corresponding service request type.

For example, referring back to FIG. 22, the service user interface data GUI 2200 may include the one or more interface elements 2202. An interface element may also correspond to an escalation request. For example, the user may interact with interface element 2202b to request to speak to a representative of the service entity. This may cause the communications hardware 206 to receive the escalation request.

Returning now to FIG. 8, as shown by operation 804, the apparatus 200 includes means, such as processor 202, memory 204, communications hardware 206, operations management circuitry 208, or the like, providing a live user session request. The operations management circuitry 208 may generate a live user session request that can be provided to the service entity device associated with the corresponding session. The live user session request may include the session token for the corresponding session and a request to connect the user to an available representative. The communications hardware 206 may then provide the live user session request to the service entity device. The communications hardware 206 may provide the live user session request using HTTP or HTTPS protocols and/or using the associated APIs, as described above.

As shown by operation 806, the apparatus 200 includes means, such as processor 202, memory 204, communications hardware 206, or the like, receiving a live user session response. Communications hardware 206 may receive a live user session response from the service entity device. The live user session may include a session link that can be used to establish a live session between the user and an available representative. In some embodiments, the session link is a HTML link or endpoint that may be used to established to establish a connection with a representative computing device associated with the available representative.

As shown by operation 808, the apparatus 200 includes means, such as processor 202, memory 204, communications hardware 206, or the like, providing the live user session response. The communications hardware 206 may then be configured to provide a live user session response to an auxiliary device. In some embodiments, the recipient auxiliary device may be a computing device that is capable of facilitating the live user session using teleconferencing or videoconferencing technology. The recipient auxiliary device may further be located in a private location such that the user may interact with the representative for the service entity in a private and secure location. The recipient auxiliary device may use the provided session link to establish the live user session with the representative computing device.

Turning now to FIG. 9, example operations are shown for terminating a session with the service entity device. Once a user has performed all desired operations and interactions for a user account for a particular service entity, the session with the corresponding service entity device may be terminated. Upon terminated the session, apparatus 200 may discard and/or clear the memory 204 of any user account information and the session token. As such, apparatus 200 may no longer store any sensitive user account data and further, may clear the session token from the memory 204 to prevent it from being reused to obtain user account information.

As shown by operation 902, the apparatus 200 includes means, such as processor 202, memory 204, communications hardware 206, operations management circuitry 208, or the like, determining a session termination event. In some embodiments, the operations management circuitry 208 may be configured to monitor for a session termination event. A session termination event may be any event that is indicative that the user has finished all desired interactions with a service entity for the corresponding user account. For example, the operations management circuitry 208 may determine that the user has not provided input for a period of time that exceeds an allotted inactivity time threshold. Thus, the operations management circuitry 208 may determine a session timeout has occurred and in response, may determine the session termination event. Alternatively, the user may provide input (e.g., using the service user interface data GUI) such that the communications hardware 206 may receive a termination event request from an auxiliary device. The operations management circuitry 208 may then determine the session termination event in response to receipt of the termination event request.

For example, referring back to FIG. 22, the service user interface data GUI 2200 may include the one or more interface elements 2202. An interface element may also correspond to a termination event. For example, the user may interact with interface element 2202c to indicate that the user has finished the desired operations and/or interactions with the particular service entity. This may cause the communications hardware 206 to receive a termination event request and may causer the operations management circuitry 208 to determine the session termination event.

Returning now to FIG. 9, as shown by operation 904, the apparatus 200 includes means, such as processor 202, memory 204, communications hardware 206, operations management circuitry 208, or the like, terminating the session with the service entity device. Once the operations management circuitry 208 has determine the session termination event, the operations management circuitry 208 may generate a session termination request. The session termination request may be indicative for the service entity device to terminate the session with apparatus 200 and delete the session token. In some embodiments, the operations management circuitry 208 may format the session termination request in accordance with a HTTP protocol or HTTPS protocol. In particular, the session termination request may include one or more headers and body. The HTTP headers may include an authorization header that contains the value of the session token, a content-type header that is indicative of the format of the data in the body. The body may of the session termination request may be empty. In some embodiments, the operations management circuitry 208 may use the service entity configuration set to determine an endpoint that is configured to support the session termination request. Alternatively, in an instance a restful API is used, the body of the session termination request may include the session termination request. The communications hardware 206 may receive a session termination response that is indicative of whether the session termination was successful (e.g., the session token was cleared from memory).

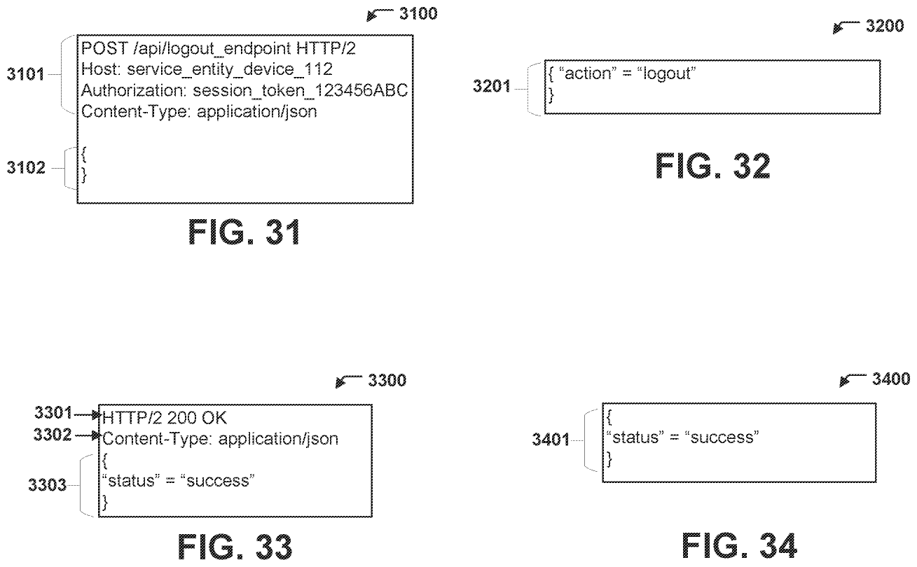

FIG. 31 depicts a first example session termination request 3100. The session termination request 3100 may be provided to a service entity device using a stateless API (e.g., a RESTful API). The session termination request 3100 includes headers 3101 and a body 3102. The headers 3101 may specify the type of HTTP request (e.g. “POST” or “DELETE”), the endpoint used terminate the session (e.g., “logout_endpoint”), and the version of the HTTP protocol (e.g., “HTTP 2”). Additionally, session termination request 3100 may include a host header that is indicative of the domain name of a recipient service entity device (e.g., “service_entity_device_112A”). The session termination request 3100 may also include an authorization header that contains the value of the session token (e.g., “session_token_123456ABC”). The session termination request may also include a content-type header that is indicative of the type of media within the body of the request (e.g., “application/json”). Here, the body of the session termination request 3100 may be empty.

FIG. 32 depicts a second example session termination request 3200. The session termination request 3200 may be provided to a service entity device using a stateful API (e.g., WebSocket). The session termination request 3200 may include a request to terminate the session in the body (e.g., “logout”).

FIG. 33 depicts a first example session termination response 3300. The session termination response 3300 may be received from a service entity device using a stateless API (e.g., a RESTful API). The session termination response 3300 may include a status line 3301 indicative of whether the request was successful and a content-type header 3302 indicative of the body format. The session termination response 3300 may further include the body 3303 that includes an indication of whether the session was successfully terminated (e.g., a session token was cleared from a memory).

FIG. 34 depicts a second example session termination response 3400. The session termination response 3400 may be received from a service entity device using a stateful API (e.g., WebSocket). The session termination response 3400 may include the body 3401 that includes an indication of whether the session was successfully terminated (e.g., a session token was cleared from a memory).

Returning now to FIG. 9, as shown by operation 906, the apparatus 200 includes means, such as processor 202, memory 204, communications hardware 206, operations management circuitry 208, or the like, clearing the session token from an associated storage. The operations management circuitry 208 may additionally clear the session token from an associated memory, such as memory 204. In particular, the operations management circuitry 208 may delete, wipe, clear the session token value from the memory 204 where the session token may be stored and/or any other storage location (e.g., a memory cache, web cache, central processing unit (CPU) cache, or the like). Thus, the session token may be cleared from the memory associated with apparatus 200 such that it cannot be used again, thereby ensuring the user account remains secure.

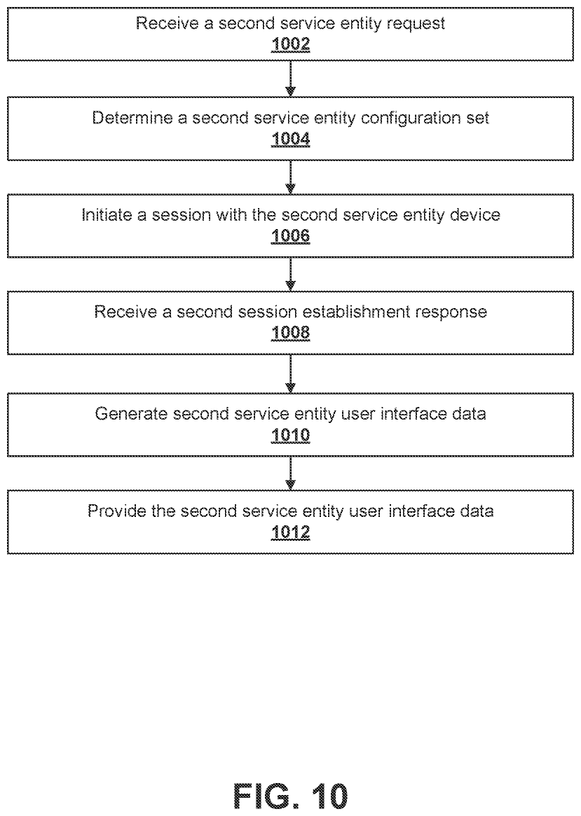

Turning now to FIG. 10, example operations are shown for establishing and facilitating a session with second a service entity device of a second service entity for a user. Apparatus may additionally facilitate a session with a second service entity that is different than the first service entity. In some embodiments, this additional session may be established and maintained concurrently and/or simultaneously with the first session with a first service entity. In doing so, this may allow users to manage user accounts across multiple service entities in real time or near real time.

As shown by operation 1002, the apparatus 200 includes means, such as processor 202, memory 204, communications hardware 206, operations management circuitry 208, or the like, for receiving a second service entity request. In some embodiments, the communications hardware may receive an additional service entity request for the apparatus 200 to facilitate a secure session between the user and a second service entity that is different from the first service entity. This second service entity request may be received at any point during the user visit to the physical branch relative to the first service entity request. For example, the second service entity request may be received at the same time as the first service entity request, while the session with a first service entity is ongoing, or after the session with the first service entity has been terminated. In some embodiments, apparatus 200 may receive the second service entity request in a manner that is substantially similar to receiving the first service entity request as described in operation 402 of FIG. 4.

As shown by operation 1004, the apparatus 200 includes means, such as processor 202, memory 204, communications hardware 206, operations management circuitry 208, or the like, for determining a second service entity configuration set. Once the communications hardware 206 has received the second service entity request, the operations management circuitry 208 may be configured to determine a service entity configuration set for the second service entity indicated by the second service entity request. The various settings, parameters, templates, interfaces, documents, instructions, and/or the like for the second service entity included in the corresponding service entity configuration set may differ from the settings, parameters, templates, interfaces, documents, instructions, and/or the like in the service entity configuration set associated with the first service entity. In some embodiments, apparatus 200 may determine the second service entity configuration set in a manner that is substantially similar to determining the first service entity configuration set as described in operation 404 of FIG. 4.

As shown by operation 1006, the apparatus 200 includes means, such as processor 202, memory 204, communications hardware 206, operations management circuitry 208, cryptographic circuitry 212, or the like, for initiating a session with the second service entity device. Once the operations management circuitry 208 determines the service entity configuration set that corresponds to the second service entity indicated by the second service entity request, the operations management circuitry 208 may determine the appropriate second service entity device for the second service entity. Additionally, the operations management circuitry 208 may use the service entity configuration set for the second service entity to identify an appropriate request format and an endpoint to provide a session establishment request. The communications hardware 206 may then initiate a session with the second service entity device by providing a second session establishment request to the second service entity device. In some embodiments, apparatus 200 may initiate a session with the second service entity device in a manner that is substantially similar to initiating a session with the first service entity device as described in operation 406 of FIG. 4.

As shown by operation 1008, the apparatus 200 includes means, such as processor 202, memory 204, communications hardware 206, or the like, for receiving a second session establishment response. Once the communications hardware 206 has provided the second session establishment request, the recipient second service entity device may perform various operations on the second session establishment request, as discussed in further detail in FIG. 12. In an instance in which the second service entity device successfully authenticates a user to which the second session establishment request pertains, the communications hardware 206 receives a second session establishment response. The second session establishment response includes a second session token that may be used to identify the particular second session between communications hardware 206 and the second service entity device and second user account data pertaining to a user account for the user managed by the second service entity. In some embodiments, apparatus 200 may receive the second session establishment response in a manner that is substantially similar to receiving the first session establishment response as described in operation 408 of FIG. 4.

As shown by operation 1010, the apparatus 200 includes means, such as processor 202, memory 204, interface circuitry 210, or the like, for generating second service entity user interface data. The interface circuitry 210 may generate second service entity user interface data based on the second user account data and the service entity configuration set associated with the second service entity. The service entity configuration set may include instructions for generating user interface templates for various user interfaces to be provided to the user. These templates may differ both in substance and design from user interface templates associated with a first service entity. In some embodiments, apparatus 200 may generate second service entity user interface data in a manner that is substantially similar to generating first service entity user interface data as described in operation 410 of FIG. 4.

As shown by operation 1012, the apparatus 200 includes means, such as processor 202, memory 204, communications hardware 206, or the like, for providing the second service entity user interface data. Once the interface circuitry 210 has generated the second service entity user interface data, the communications hardware 206 may provide the second service entity user interface data to an auxiliary device (e.g., any one of auxiliary devices 116A-116N). In some embodiments, the communications hardware 206 may provide the second service entity user interface data to an auxiliary device that is a different auxiliary device than the auxiliary device that was provided with the first service entity user interface data. Thus, multiple auxiliary devices may be used such that the both first service entity user interface data corresponding to a first service entity and second service entity user interface data corresponding to a second service entity may be viewed by the user simultaneously. Alternatively, the second service entity user interface data to the same auxiliary device that was provided with the first service entity user interface data. In some embodiments, the auxiliary device may be configured to present both the first service entity and second service entity user interface data corresponding to a second service entity may be viewed by the user simultaneously, such as by using multiple displays or displaying the data side-by-side on a single display. Alternatively, in some embodiments, the communications hardware 206 may be configured to wait until the session with the first service entity has terminated and then may provide the second service entity user interface data to the auxiliary device. Additionally, the operations described in FIGS. 5-9 may be performed for the session with the second service entity.

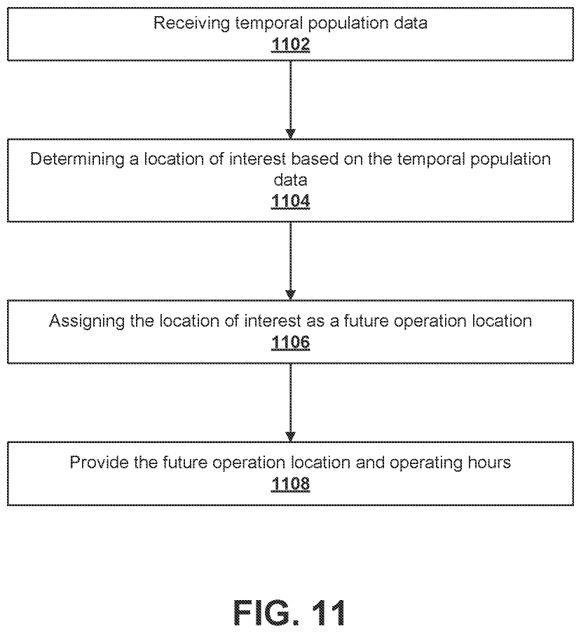

Turning now to FIG. 11, example operations are shown for determining a future location. In some embodiments, the physical branch may be mobile such that the location of the physical branch associated with apparatus 200 may be flexible and change. Thus, in some embodiments, apparatus 200 may be tasked with determining a future location for the physical branch and may provide the indication of this future location to various users, service entities, and/or agents. The future locations may be selected based on an inferred need for services offered by the physical branch at various locations and at various time.

As shown by operation 1102, the apparatus 200 includes means, such as processor 202, memory 204, communications hardware 206, or the like, for receiving temporal population data. In some embodiments, the communications hardware 206 may receive temporal population data from one or more data sources. In some embodiments, the data sources may include one or more service entity devices (e.g., any one of service entity devices 112A-112N) and/or user devices (e.g., any one of user devices 106A-106N). In some embodiments, the temporal population data may be indicative of a user need for services in a particular area at a particular time. For example, temporal population data received from a service entity device may describe a volume of services provided to users at particular service entity locations at a particular time.

As shown by operation 1104, the apparatus 200 includes means, such as processor 202, memory 204, location determination circuitry 214, or the like, for determining a location of interest based on the temporal population data. Location determination circuitry 214 may analyze the temporal population data to identify a location of interest. In some embodiments, the location determination circuitry 214 may be configured to use a location selection model. The location selection model may be a machine learning model that is configured to predict potential locations of interest based on an inferred need for services. In some embodiments, the location selection model may be a decision tree or a neural network configured to use a suitable clustering algorithms to determine a candidate locations of interest. The location selection model may determine a particular location of interest from the candidate locations of interest by determining which future location is inferred to have the greatest need for services. Additionally, the candidate locations may be predefined locations that the location selection model may select from. These predefined locations may be locations that may be utilized by the physical branch for a period of time (e.g., store fronts, pop-up lots, and/or the like). Furthermore, the location selection model may determine a corresponding in-demand operating period. The in-demand operating period may be indicative of a window of time for which the location of interest is inferred to have the greatest need for services (e.g., 9:00 am through 11:00 am).

As shown by operation 1106, the apparatus 200 includes means, such as processor 202, memory 204, location determination circuitry 214, or the like, for assigning the location of interest as a future operation location. Once the location determination circuitry 214 has determined the location of interest, the location determination circuitry 214 may assign the location of interest as a future location. A future location may be a location where the physical branch will operate for a set period of time (e.g., hours, days, months, etc.).

Additionally, the location determination circuitry 214 may determine associated operating hours for the physical branch at the future location. The location determination circuitry 214 may determine operating hours for the physical branch based on the in-demand operating period and based on agent availability.

As shown by operation 1108, the apparatus 200 includes means, such as processor 202, memory 204, communications hardware 206, location determination circuitry 214, or the like, for providing the future operation location and operating hours. The communications hardware 206 may provide the future operation location and operating hours to one or more service entity devices (e.g., any one of service entity devices 112A-112N), one or more user devices (e.g., any one of user devices 106A-106N), and one or more agent devices (108A-108N). Recipient users may then be provided with an indication of a future location for the physical branch and may make adjustments and/or plans for interactions with the physical branch based on this provided information.

### Service Entity Device Operations

Turning to FIGS. 12-15, example flowcharts are illustrated that contain example operations implemented by example embodiments described herein. The operations illustrated in FIGS. 12-15 may, for example, be performed by a service entity device (e.g., any one of service entity devices 112A-112N) of the operation management system 102 shown in FIG. 1, which may in turn be embodied by an apparatus 300, which is shown and described in connection with FIG. 3. To perform the operations described below, the apparatus 300 may utilize one or more of processor 302, memory 304, communications hardware 306, authentication circuitry 308, session management circuitry 310, cryptographic circuitry 312, and/or operations circuitry 314, and/or any combination thereof.

Turning first to FIG. 12, example operations are shown for establishing and facilitating a session with a system for a user.

As shown by operation 1202, the apparatus 300 includes means, such as processor 302, memory 304, communications hardware 306, cryptographic circuitry 312, or the like, for receiving a session establishment request. The communications hardware 306 may receive the session establishment request from a system device 110. The session establishment request may include a user identifier, a user credential, and in some embodiments, a device identifier that corresponds to the system device 110.

In some embodiments, the circuitry of apparatus 300 may be configured to access and utilization an operation management system configuration set in response to communications that involve the system device. The operation management system configuration set may store settings, parameters, templates, interfaces, documents, instructions, and/or the like for the operation management system. In some embodiments, the operation management system configuration set may include an indication of one or more system device identifiers that are authenticate and/or authorized system devices associated with the operation management system 102. Additionally, the operation management system configuration set may include instructions for cryptographic circuitry 312 to use a symmetric encryption algorithm or asymmetric encryption algorithm and/or may include instructions on the specific encryption algorithm to use to encrypt data for the system device and/or a symmetric decryption algorithm or asymmetric decryption algorithm and/or may include instructions on the specific decryption algorithm to use to decrypt data received from the system device. Thus, apparatus 300 may use the operation management system configuration set to process requests received from the system device 110 and to generate responses for system device 110.

In some embodiments, data within the session establishment request may be encrypted such that cryptographic circuitry 312 may be required to decrypt the data. In particular, the user credential and in some embodiments, the user identifier and/or device identifier may be encrypted. The cryptographic circuitry 312 may decrypt the encrypted data using a corresponding decryption algorithm. In some embodiments, the operation management system configuration set may include instructions for the cryptographic circuitry 312 to use a specific decryption algorithm. In some embodiments, the service entity configuration set may further indicate the particular cryptographic key to be used with the decryption algorithm. For example, the operation management system configuration set may specify that the encrypted data was encrypted using an asymmetric encryption algorithm such that the cryptographic circuitry 312 may use a private key of an asymmetric cryptographic key pair associated with apparatus 300 to decrypt the encrypted data. Alternatively, the operation management system configuration set may specify that the encrypted data was encrypted using a symmetric encryption algorithm such that the cryptographic circuitry 312 may use a symmetric key shared between apparatus 300 and the system device to decrypt the encrypted data.

As shown by operation 1204, the apparatus 300 includes means, such as processor 302, memory 304, authentication circuitry 308, or the like, for identifying a user account. The authentication circuitry 308 may use the user identifier provided in the session establishment request to identify a corresponding user account for the user. In particular, the user identifier may be a value that uniquely identifies the user account. As such, the authentication circuitry 308 may query an associated memory, such as memory 304, which stores user accounts for the user account indicated by the user identifier. The user account may include user account data, such as user personal data (e.g., name, address, phone number, email, date of birth, identification number, and/or the like), user account details (e.g., user account type, user account number, status of user account, a date of the user account opening, a date of the user account closing), an associated transaction history, user account balances, scheduled transactions, current available financial product offers, safe deposit box information, credit information (e.g., credit lines, credit limits, credit history), loan information (e.g., loan amount, loan repayment schedule, interest rates, payment history, outstanding balance), user account security information (e.g., fraud alerts, security questions, unusual activity flags, or the like), and/or the like. The user account may further be associated with a user credential that may be used to authenticate a candidate user.

As shown by operation 1206, the apparatus 300 includes means, such as processor 302, memory 304, authentication circuitry 308, or the like, for performing an authentication routine to authenticate the user. The authentication circuitry 308 may perform an authentication routine to determine whether the provided user credential corresponds to the user credential stored in the user account. In some embodiments, prior to authenticating the user, the authentication circuitry 308 may first verify if the device identifier provided in the session establishment request corresponds to a device identifier indicated as an authentic device in the operation management system configuration set. In an instance the operation management system configuration set includes a device identifier that matches the device identifier included in the session establishment request, the authentication circuitry 308 may determine the system device is authenticated and may proceed to perform the authentication routine to authenticate the user. In an instance the operation management system configuration set does not include a device identifier that matches the device identifier included in the session establishment request, the process may proceed directly to operation 1210.

The authentication circuitry 308 may use any suitable authentication techniques to perform the authentication routine and determine whether the provided user credential corresponds to the stored user credential. For example, a candidate user credential that is text (e.g., a PIN, password, or the like) may be directly compared to the stored user credential and in an instance the two values exactly match, the authentication circuitry 308 may determine the user is successfully authenticate. If the two values do not match, the authentication circuitry 308 may determine the user has failed to be authenticated. Alternatively, the provided user credential may be a biometric user credential. Thus, the authentication circuitry 308 may perform a similarity analysis, such as by using various biometric authentication machine learning models, to determine whether the provided user credential sufficiently matches (e.g., satisfies a similarity threshold) the stored user credential. In an instance in which the provided user credential sufficiently matches the stored user credential, the authentication circuitry 308 may determine that the user is successfully authenticated. In an instance in which the provided user credential does not sufficiently match the stored user credential, the authentication circuitry 308 may determine the user has failed to be authenticated.

As shown by operation 1208, the apparatus 300 includes means, such as processor 302, memory 304, authentication circuitry 308, or the like, for determining whether the user was authenticated. In an instance the user failed to be successfully authenticated, the process may proceed to operation 1210. In an instance the user was successfully authenticated, the process may proceed to operation 1212.

As shown by operation 1210, the apparatus 300 includes means, such as processor 302, memory 304, communications hardware 306, or the like, for rejecting a session establishment request. In an instance in which the user failed to be successfully authenticated, the communications hardware 306 may reject the session establishment request. In some embodiments, the communications hardware 306 may provide a session establishment response that indicates the user could not be verified and that the session could not be established.

As shown by operation 1212, the apparatus 300 includes means, such as processor 302, memory 304, communications hardware 306, session management circuitry 310, or the like, for generating a session token. In some embodiments, the session management circuitry 310 may generate a session token using any suitable token generation algorithm. For example, the session management circuitry 310 may generate the session token using a pseudo-random number generation algorithm, a cryptographic pseudo-random number generation algorithm, various hashing algorithms, and/or the like. In some embodiments, the session management circuitry 310 may format the session token in a particular format, such as a JSON web token. In some embodiments, the session token may further be associated with an expiration time. After the expiration time, the session token may no longer be valid. Additionally, the session management circuitry 310 may store the session token in an associated memory, such as memory 304.

As shown by operation 1214, the apparatus 300 includes means, such as processor 302, memory 304, session management circuitry 310, cryptographic circuitry 312, or the like, for generating a session establishment response. The session management circuitry 310 may generate the session establishment response that includes he session establishment response includes the session token and user account data pertaining to identified user account for the user. In this way, the system device may be provided with the information needed to facilitate interaction with the user on behalf of the apparatus 300.

In some embodiments, the session management circuitry 310 may determine the operation management system configuration set is indicative to protect a portion or all of the data included in the session establishment response. In particular, the operation management system configuration set may include instructions for the cryptographic circuitry 312 to use either a symmetric encryption algorithm or asymmetric encryption algorithm and/or may include instructions on the specific encryption algorithm to use. In some embodiments, the operation management system configuration set may further indicate the particular cryptographic key to be used with the encryption algorithm. The cryptographic circuitry 312 may then protect the data (e.g., the session token and/or the user account data) using the defined encryption technique. The cryptographic circuitry 312 may use any suitable cryptographic technique to encrypt the data. In some embodiments, apparatus 300 and the system device may have established a shared cryptographic key (e.g., a symmetric cryptographic key) with one another. Thus, the cryptographic circuitry 312 may protect the data within the session establishment response using a symmetric encryption algorithm (e.g., an AES algorithm, a DES algorithm, a Blowfish algorithm, or a Rivest Cipher algorithm, such as RC4, RC5, or RC6). Alternatively, the cryptographic circuitry 312 may use a public cryptographic key of an asymmetric cryptographic key pair associated with system device to encrypt the data within the session establishment response using an asymmetric encryption algorithm (e.g., a RSA algorithm).

Additionally, the session management circuitry 310 may generated the session establishment response in accordance with HTTP or HTTPS protocols with appropriate headers and body, as defined by the service entity configuration set. In some embodiments, the session establishment response may be provided using various APIs. The particular protocols and/or APIS used may be dependent on the format requested in the session establishment request.

As shown by operation 1216, the apparatus 300 includes means, such as processor 302, memory 304, communications hardware 306, or the like, for providing the session establishment response. The communications hardware 306 may then provide the session establishment response to the system device.

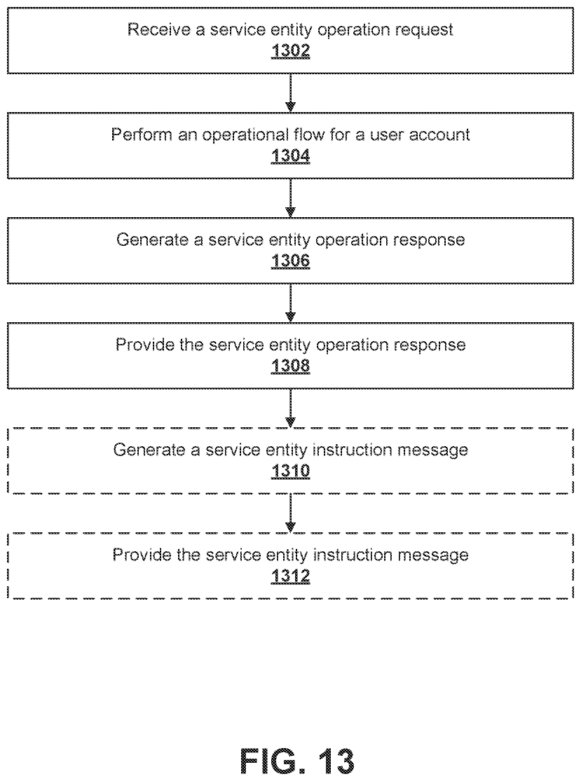

Turning next to FIG. 13, example operations are shown for performing an operational flow for a user account in response to a service entity operation request.

As shown by operation 1302, the apparatus 300 includes means, such as processor 302, memory 304, communications hardware 306, cryptographic circuitry 312, or the like, for receiving a service entity operation request. The communications hardware 306 may receive the service entity request from the system device with whom a session has been established. The service entity request may include the session token that was provided to the system device in the session establishment response. The service entity request may additionally include a service request type and one or more service request parameters. The service request type may correspond to a service request made by the user. The communications hardware 306 may verify that the token included in the session establishment response matches the stored token in the session to verify the request. In an instance in which the request is verified, the process may proceed to operation 1304. In an instance in which the request is verified, a rejection message may be provided to the system device and may indicate the request could not be handled.

In some embodiments, data within the service entity operation request may be encrypted such that cryptographic circuitry 312 may be required to decrypt the data. The cryptographic circuitry 312 may be configured to decrypt the data in a similar manner as described in operation 1202 of FIG. 12.

As shown by operation 1304, the apparatus 300 includes means, such as processor 302, memory 304, communications hardware 306, operations circuitry 314, or the like, for performing an operational flow for the user account. In some embodiments, an operational flow repository may store one or more operational flows. An operational flow may describe one or more sequential operations that operations circuitry 314 may perform to facilitate a service request for the user. Each operational flow may correspond to a particular service request type. The one or more operations may be dependent upon the service request type. In some embodiments, the one or more operations may involve modifications to a user account. For example, an operational flow corresponding to a “withdraw funds” service request type may include operations to deduct a specific amount of funds from an account balance of a selected user account. Thus, in an instance the service entity operation request indicates a “withdraw funds” service request type for an amount of $100, the operations circuitry 314 may subtract the amount of $100 from the requested user account to perform the operational flow.

In some embodiments, the operational flow may require the operations circuitry 314 provide the user with one or more documents corresponding to a document type. The one or more documents may be stored with the operational flow such that the operations circuitry 314 may directly access the required documents to include in a service entity operation response.

As shown by operation 1306, the apparatus 300 includes means, such as processor 302, memory 304, cryptographic circuitry 312, operations circuitry 314, or the like, for generating a service entity operation response. In some embodiments, the operations circuitry 314 may generate a service entity operation response. The service entity operation response may be indicative of whether an operational flow corresponding to the service request type was successfully performed. In an instance the operational flow was successfully performed, the operational flow may apparatus 300 performed operations associated with the service request type for the user and/or user device. The service entity operation response may further include updated user account data. Furthermore, in some embodiments, the service entity operation response may include required documents if required by the operational flow.

In some embodiments, the session management circuitry 310 may determine the operation management system configuration set is indicative to protect a portion or all of the data included in the service entity operation response. In particular, the operation management system configuration set may include instructions for the cryptographic circuitry 312 to use either a symmetric encryption algorithm or asymmetric encryption algorithm and/or may include instructions on the specific encryption algorithm to use. In some embodiments, the operation management system configuration set may further indicate the particular cryptographic key to be used with the encryption algorithm. The cryptographic circuitry 312 may then protect the data (e.g., the updated user account data) using the defined encryption technique. The cryptographic circuitry 312 may protect the data in a manner that is substantially similar to operation 1214 of FIG. 12.

Additionally, the operations circuitry 314 may generate the service entity operation response in accordance with HTTP or HTTPS protocols with appropriate headers and body, as defined by the service entity configuration set. In some embodiments, the service entity operation response may be provided using various APIs. The particular protocols and/or APIS used may be dependent on the format requested in the session establishment request.

As shown by operation 1308, the apparatus 300 includes means, such as processor 302, memory 304, communications hardware 306, operations circuitry 314, or the like, for providing the service entity operation response. The communications hardware 306 may provide the service entity operation response to the system device.

Optionally, as shown by operation 1310, the apparatus 300 includes means, such as processor 302, memory 304, operations circuitry 314, or the like, for generating a service entity instruction message. In some embodiments, the operations circuitry 314 may determine the operational flow for the service request type is further indicative to provide a service entity instruction message. The operational flow may include a service entity instruction message template that the operations circuitry 314 may updated based on the service request parameters and/or updated user account data. For example, a service entity instruction message template may include instructions for an agent to provide the user with funds. The operations circuitry 314 may update the service entity instruction message template to reflect the amount of funds.

Additionally, the operations circuitry 314 may generate the service entity instruction message in accordance with HTTP or HTTPS protocols with appropriate headers and body, as defined by the service entity configuration set. In some embodiments, the service entity instruction message may be provided using various APIs. The particular protocols and/or APIS used may be dependent on the format requested in the session establishment request.

Optionally, as shown by operation 1312, the apparatus 300 includes means, such as processor 302, memory 304, communications hardware 306, or the like, for providing the service entity instruction message. The communications hardware 306 may provide the service entity instruction message to the system device

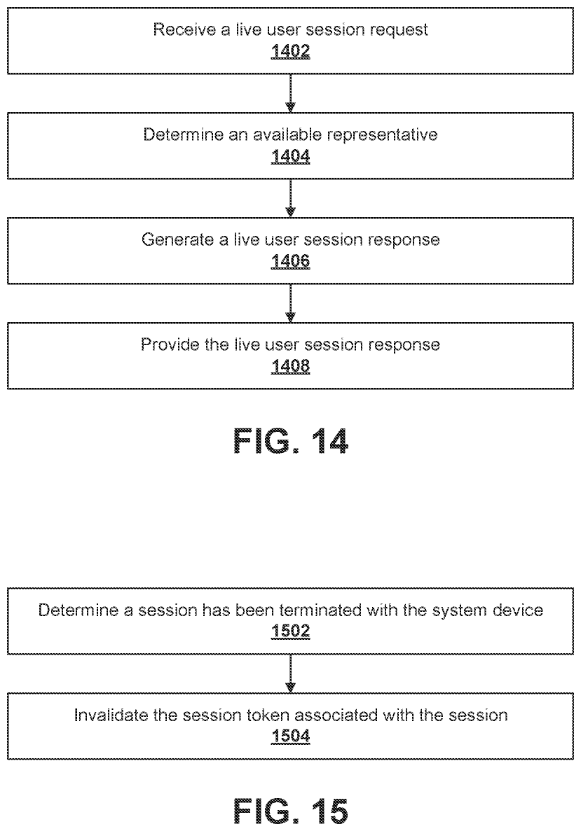

Turning next to FIG. 14, example operations are shown for facilitating a live user session request with a user.

As shown by operation 1402, the apparatus 300 includes means, such as processor 302, memory 304, communications hardware 306, or the like, for receiving a live user session request. The communications hardware 306 may receive a live user session request from the system device. The live user session request may include the session token for the corresponding session and a request to connect the user to an available representative.

As shown by operation 1404, the apparatus 300 includes means, such as processor 302, memory 304, communications hardware 306, operations circuitry 314, or the like, for determining an available representative. In response to receipt of the live user session request, the operations circuitry 314 may determine an available representative that may speak with the user to resolve a concern or facilitate a more complex user request. In some embodiments, the operations circuitry 314 may be configured to analyze one or more representative profiles. A representative profile may include a representative status the representative. The representative status may be indicative of whether the corresponding representative is currently available. The representative profile may additionally be associated with an associated representative device used by the representative. The operations circuitry 314 may then select a representative based on the representative status. Said otherwise, the operations circuitry 314 may select a representative that is currently available.

As shown by operation 1406, the apparatus 300 includes means, such as processor 302, memory 304, operations circuitry 314, or the like, for generating a live user session response. Once operations circuitry 314 has determined an available representative, the operations circuitry 314 may generate the live user session response. The live user session response may include a session link that can be used to establish a live session between the user and the available representative via the representative device. In some embodiments, the session link is a HTML link or endpoint that may be used to established to establish a connection with a representative computing device associated with the available representative.

Additionally, the operations circuitry 314 may generate the live user session response in accordance with HTTP or HTTPS protocols with appropriate headers and body, as defined by the service entity configuration set. In some embodiments, the live user session response may be provided using various APIs. The particular protocols and/or APIS used may be dependent on the format requested in the session establishment request.

As shown by operation 1408, the apparatus 300 includes means, such as processor 302, memory 304, communications hardware 306, or the like, for providing the live user session response. The communications hardware 306 may then provide the live user session response to the system device.

Turning next to FIG. 15, example operations are shown for terminating a session with the system device.

As shown by operation 1502, the apparatus 300 includes means, such as processor 302, memory 304, communications hardware 306, session management circuitry 310, or the like, for determining the session has been terminated with the system device. In some embodiments, the session management circuitry 310 may determine the expiration time associated with session token has passed such that the session token is no longer valid. As such, the session management circuitry 310 may determine the session has been terminated. Alternatively, the communications hardware 306 may receive a session termination request from the system device and the session management circuitry 310 may determine the session has been terminated in response to this receipt.

As shown by operation 1502, the apparatus 300 includes means, such as processor 302, memory 304, session management circuitry 310, or the like, for invalidating the session token associated with the session. The session management circuitry 310 may invalidate the session token such that is no longer associated with a valid status. In some embodiments, the session management circuitry 310 may further clear the session token from an associated memory, such as memory 304. Thus, apparatus 300 may no longer recognize the session token as being valid for the session with the system device.

FIGS. 4-15 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

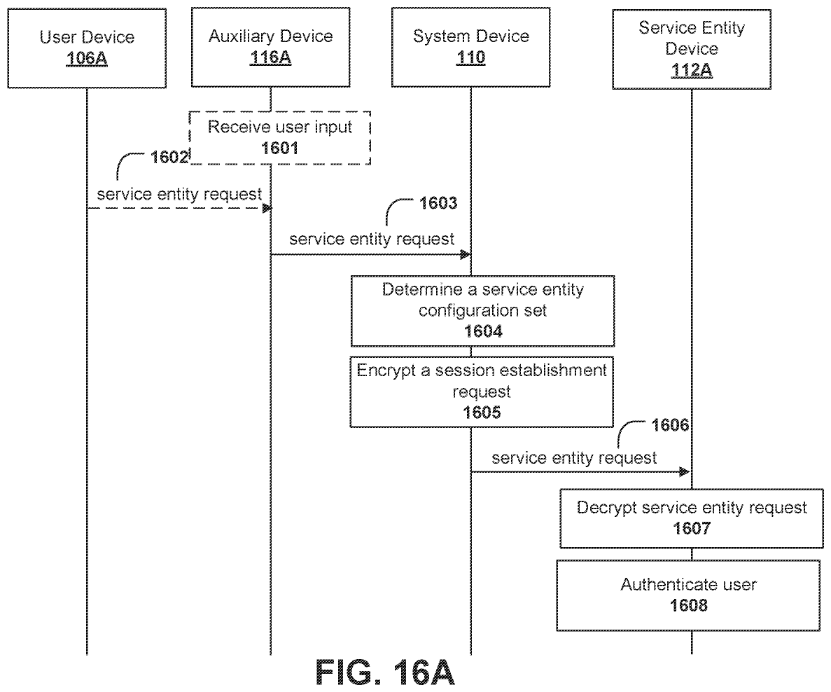

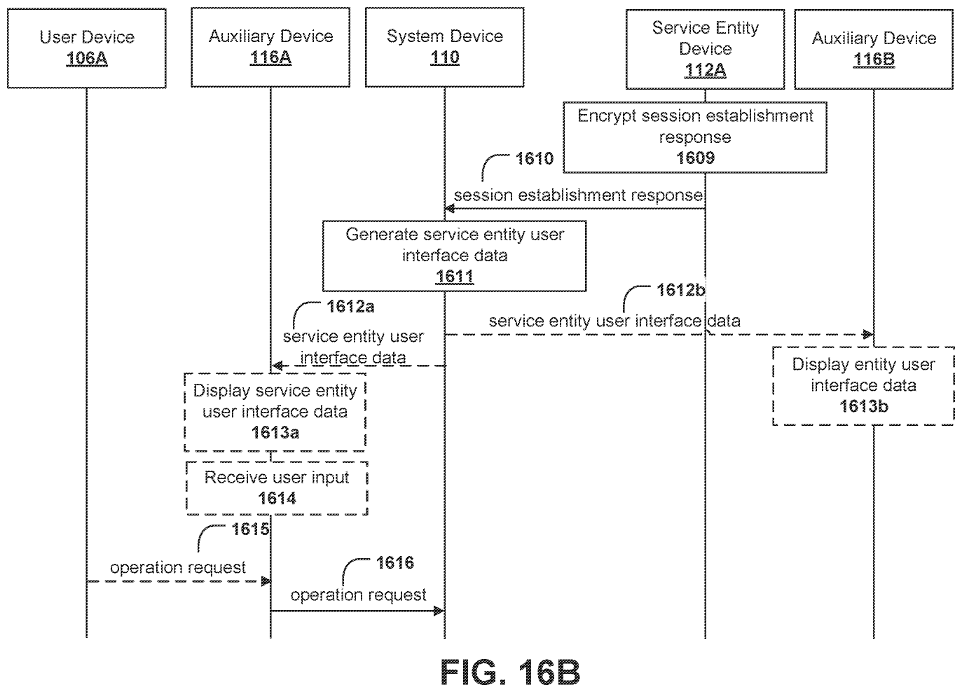

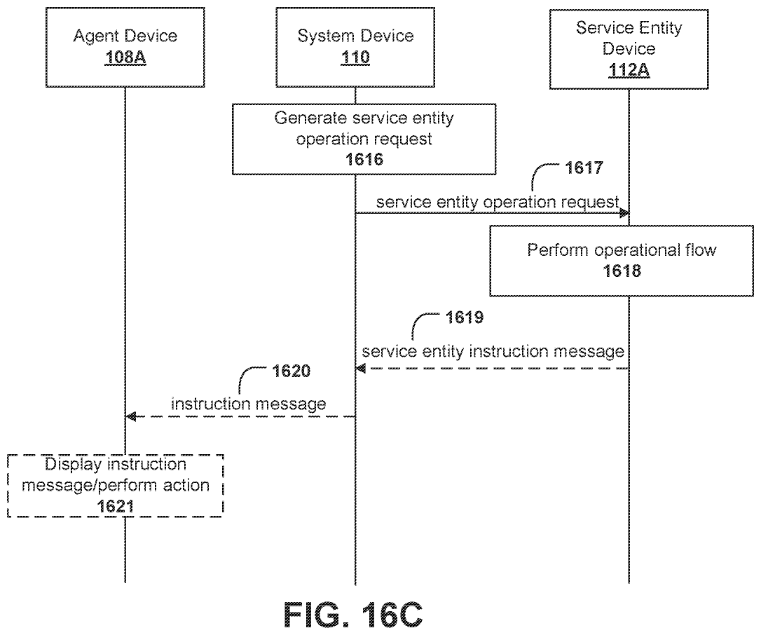

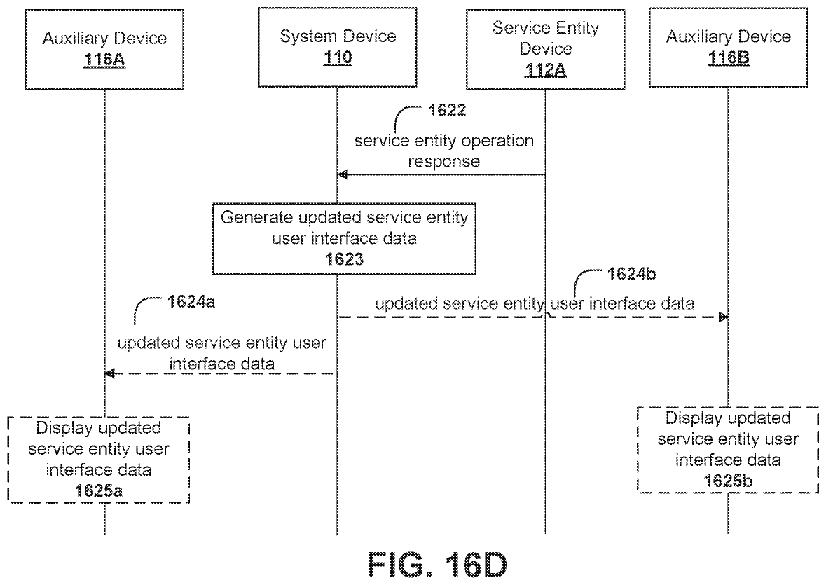

FIGS. 16A-21B shows a swim lane diagram illustrating example operations (e.g., as described above in connection with FIGS. 4-15) performed by components of the environment depicted in FIG. 1 to produce various benefits of the implementations described herein. The operations shown in the swim lane diagram performed by user device are shown along the line extending from the box labeled “user device 106A.” Operations performed by an auxiliary device are shown along the line extending from the box labeled “auxiliary device 116A,” “auxiliary device 116B,” “auxiliary device 116C,” “auxiliary device 116D,” “auxiliary device 116E,” and/or “auxiliary device 116F.” Operations performed by a system device are shown along the line extending from the box labeled “system device 110.” Operations performed by a service entity device associated with a first service entity are shown along the line extending from the box labeled “service entity device 112A.” Operations performed by a service entity device associated with a second service entity are shown along the line extending from the box labeled “service entity device 112B.” Operations performed by a representative device are shown along the line extending from the box labeled “representative device 180.” Operations impacting multiple devices, such as data transmissions between the devices, are shown using arrows extending between these lines. Generally, these operations are ordered temporally with respect to one another. However, it will be appreciated that the operations may be performed in other orders from those illustrated in FIGS. 16A-21B.

FIGS. 16A-16D illustrate example operations that may be used to establish a session between a system device and service entity device. Turning first to FIG. 16A, optionally, at operation 1601, auxiliary device 116A may receive user input from a user. Additionally or alternatively, at operation 1602, the auxiliary device 116A may receive a service entity request from a user device 106A. At operation 1603, the auxiliary device 116A may provide a service entity request to the system device 110. At operation 1604, the system device 110 may determine a service entity configuration set that is associated with a service entity indicated by the service entity request. At operation 1605, the system device 110 may encrypt a session establishment request. At operation 1606, the system device 110 may provide a service entity request to the service entity device 112A. At operation 1607, the service entity device 112A may decrypt the service entity request. At operation 1608, the service entity device 112A may perform an authentication routine to authenticate the user and/or system device.

Turning now to FIG. 16B, the service entity device 112A may generate and encrypt a session establishment response. At operation 1610, the service entity device 112A may provide the session establishment response to system device 110. At operation 1611, the system device 110 may generate service entity user interface data. At operation 1612a, the system device 110 may provide service entity user interface data to auxiliary device 116A. Alternatively, at operation 1612b, the system device 110 may provide service entity user interface data to auxiliary device 116B. At operation 1613a, the auxiliary device 116A may display the service entity user interface data. Alternatively, at operation 1613b, the auxiliary device 116B may display the service entity user interface data. Optionally, at operation 1614, the auxiliary device 116A may receive user input. Alternatively, at operation 1615, the auxiliary device 116A may receive an operation request from the user device 106A. At operation 1616, the auxiliary device 116A may provide the operation request to system device 110.

Turning now to FIG. 16C, at operation 1616, the system device 110 may generate the service entity operation request. At operation 1617, the system device 110 may provide the service entity operation request to the service entity device 112A. At operation 1618, the service entity device 112A may perform the operational flow to facilitate the service request type. At operation 1619, the service entity device 112A may provide a service entity instruction message to the system device 110. At operation 1620, the system device may provide an instruction message to agent device 108A. At operation 1621, the agent device 108 may display the instruction message and/or perform an instructed action.

Turning now to FIG. 16D, at operation 1622, the service entity device 112A may provide a service entity operation response. At operation 1623, the system device 110 may generate updated service entity user interface data. At operation 1624a, the system device, the system device 110 may provide updated service entity user interface data to auxiliary device 116A. Alternatively, at operation 1624b, the system device 110 may provide updated service entity user interface data to auxiliary device 116B. At operation 1625a, the auxiliary device 116A may display the updated service entity user interface data. Alternatively, at operation 1625b, the auxiliary device 116B may display the updated service entity user interface data.

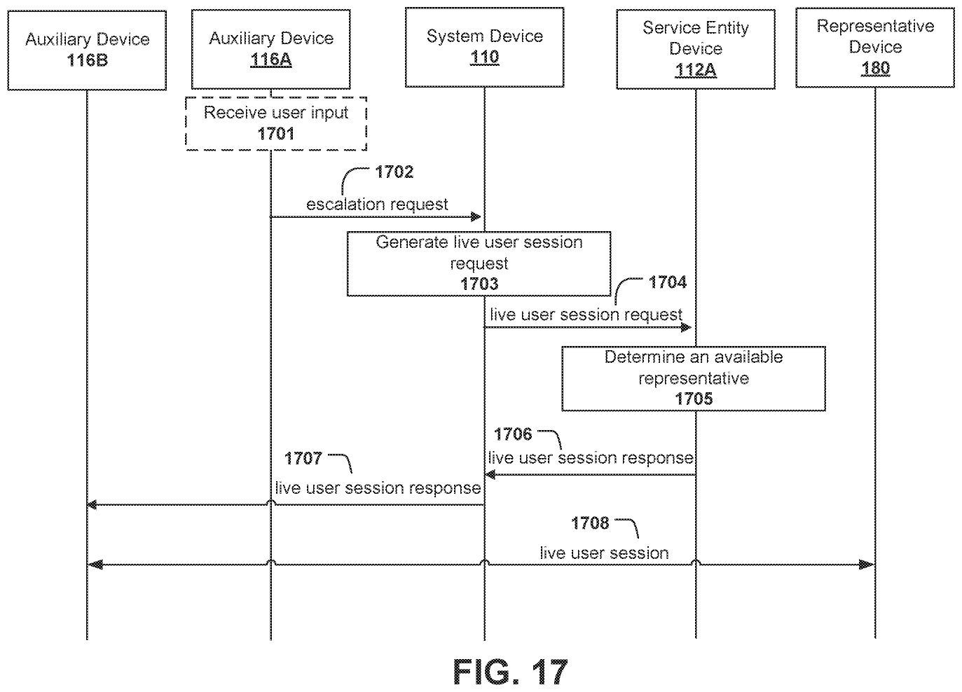

Turning next to FIG. 17, example operations are shown that may be used to facilitate a live user session. At operation 1701, auxiliary device 116A may receive user input from a user and/or from a user device 106A (not shown). At operation 1702, the auxiliary device 116A may provide an escalation request to system device 110. At operation 1703, the system device 110 may generate a live user session request. At operation 1704, the system device 110 may provide the live user session request to the service entity device 112A. At operation 1705, the service entity device 112A may determine an available representative. At operation 1706, the service entity device 112A may provide the live user session response to the system device 110. At operation 1707, the system device 110 may provide the live user session response to auxiliary device 116B. At operation 1708, the auxiliary device 116B and representative device 180 may establish a connection for the live user session.

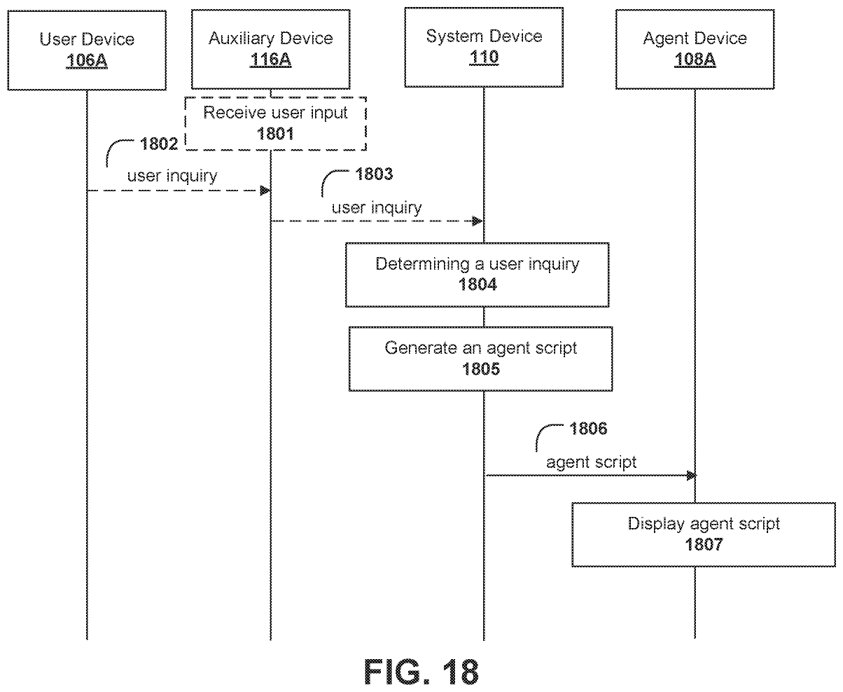

Turning now to FIG. 18, example operations are shown that may be used to provide an agent script to an agent. At operation 1801, auxiliary device 116A may receive user input from a user. Additionally or alternatively, at operation 1802, the auxiliary device 116A may receive a user inquiry from a user device 106A. At operation 1803, the auxiliary device 116B may provide the user inquiry to the system device. At operation 1804, the system device 110 may determine a user inquiry. At operation 1805, the system device 110 may generate an agent script. At operation 1806, the system device 110 may provide the agent script to agent device 108A. At operation 1807, the agent device 108A may display the agent script.

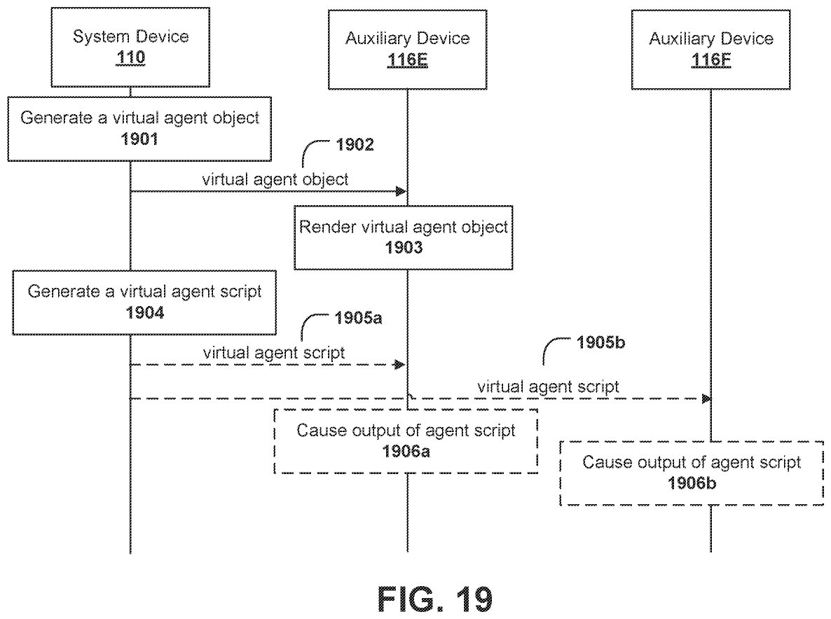

Turning now to FIG. 19, example operations are shown that may be used to provide a virtual agent object. At operation 1901, the system device 110 may generate a virtual agent object. At operation 1902, the system device 110 may provide the virtual agent object to auxiliary device 116E. At operation 1903, the auxiliary device 116E may render the virtual agent object. At operation 1904, the system device 110 may generate a virtual agent script. At operation 1905a, the system device 110 may provide the virtual agent script to auxiliary device 116E. Alternatively, at operation 1905b, the system device 110 may provide the virtual agent script to auxiliary device 116F. At operation 1906a, the auxiliary device 116E may cause output of the agent script. Alternatively, at operation 1906b, the auxiliary device 116F may cause output of the agent script.

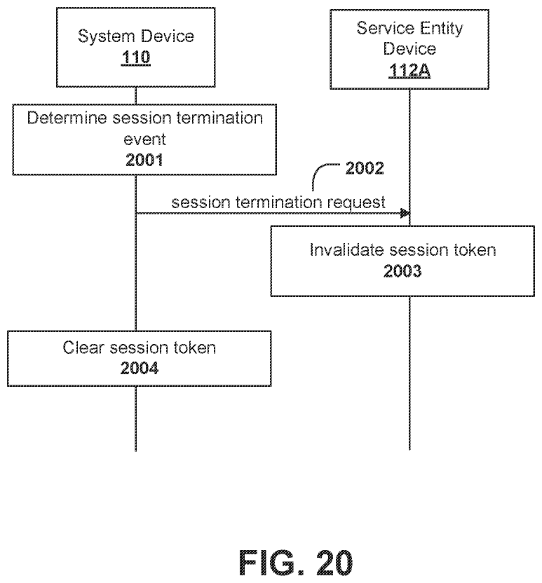

Turning now to FIG. 20, example operations are shown that may be used to terminate a session between a system device and a service entity device. At operation 2001, the system device 110 may determine a session termination event. At operation 2002, the system device 110 may provide the session termination request to service entity device 112A. At operation 2003, the service entity device 112A may invalidate the session token for the session with system device 110. At operation 2004, the system device may clear the session token from an associated memory.

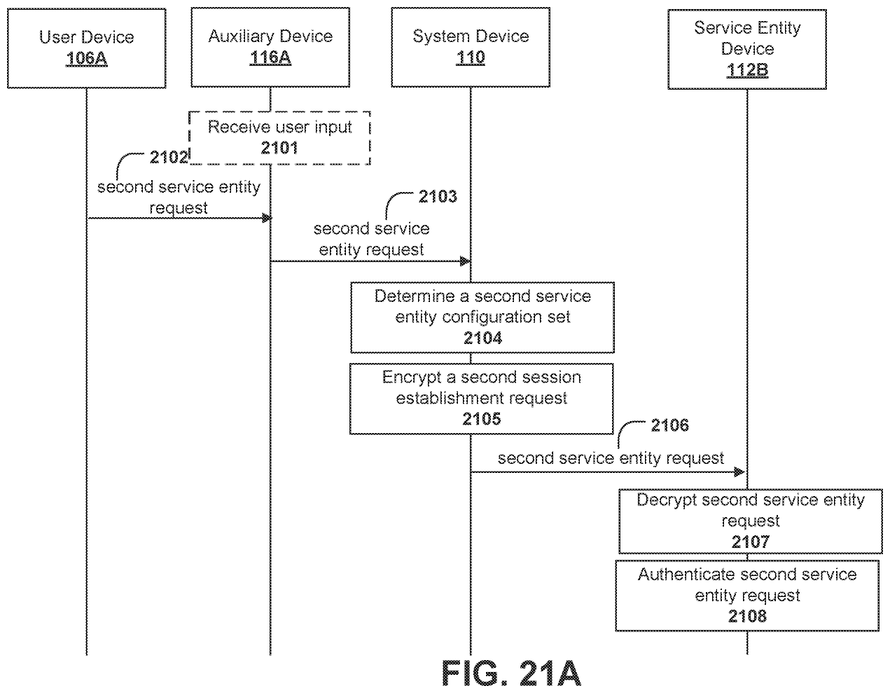

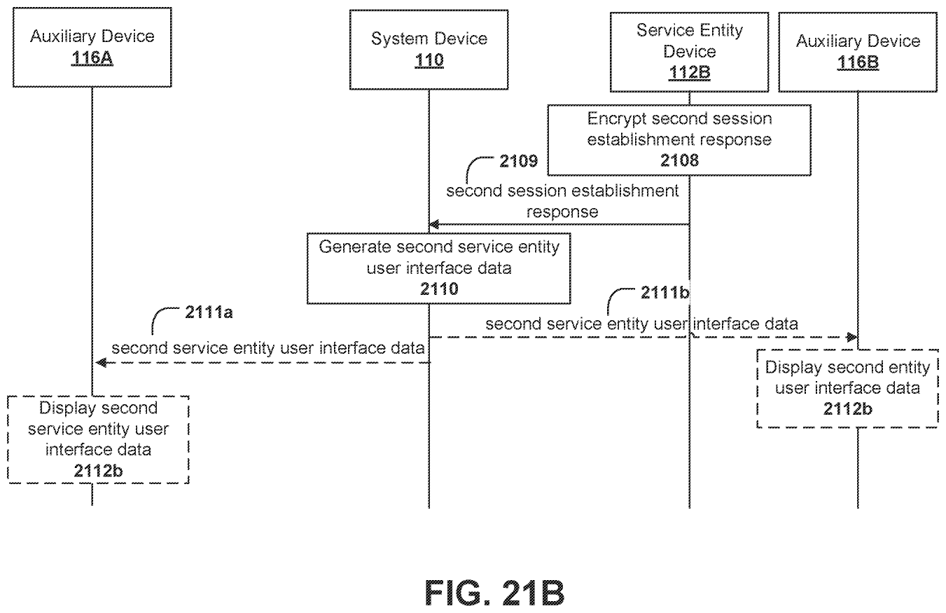

Turning now to FIGS. 21A-21B, example operations may be used to establish a session between a system device and second service entity device. Turning first to FIG. 21A, optionally, at operation 2101, auxiliary device 116A may receive user input from a user. Additionally or alternatively, at operation 2102, the auxiliary device 116A may receive a second service entity request from a user device 106A. At operation 2103, the auxiliary device 116A may provide a second service entity request to the system device 110. At operation 2104, the system device 110 may determine a service entity configuration set that is associated with a second service entity indicated by the second service entity request. At operation 2105, the system device 110 may encrypt a second session establishment request. At operation 2106, the system device 110 may provide a second service entity request to the service entity device 112B. At operation 2107, the service entity device 112B may decrypt the second service entity request. At operation 2108, the service entity device 112B may perform an authentication routine to authenticate the user and/or system device.

Turning now to FIG. 21B, the service entity device 112B may generate and encrypt a second session establishment response. At operation 2110, the service entity device 112B may provide the second session establishment response to system device 110. At operation 2111, the system device 110 may generate second service entity user interface data. At operation 2112a, the system device 110 may provide second service entity user interface data to auxiliary device 116A. Alternatively, at operation 2112b, the system device 110 may provide second service entity user interface data to auxiliary device 121B. At operation 2113a, the auxiliary device 116A may display the second service entity user interface data. Alternatively, at operation 2113b, the auxiliary device 121B may display the second service entity user interface data.

In some embodiments, some of the operations described above in connection with FIGS. 16A-21B may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses that enable a system device to act as a universal point of service that is agnostic to any one particular financial institution and is capable of allowing customers of any financial institution to perform actions for their user accounts with various financial institutions. Thus, example embodiments described herein provide a significant technical improvement to current user account operations and management by leveraging advanced inter-service entity communications to enable a streamlined and unified banking experience that has not been traditionally available. This solution drastically reduces the redundancy of having multiple bank branches associated with different financial institutions operating in close proximity by consolidating services into a single location, thereby allowing for a more efficient user of physical space and personnel.

Furthermore, the system may use of APIs provide the system with a flexible and scalable architecture that has not conventionally been available for financial institutions in this context. By using APIs, example embodiments facilitate a standardized method of communication between disparate service entity systems that allows for interoperability between the system and multiple service entities. Furthermore, this system may allow for multiple sessions to be established with different service entities for the user to facilitate unparalleled convenience. Furthermore, in some embodiments, the system may use establish and maintain sessions with different service entity devices simultaneously, via parallel processing, such that various communications and operations between a system device and various service entity devices may be performed real time or near real time. Thus, this may allow users to manage user accounts across multiple service entities in real time or near real time. Additionally, the flexible architecture of example embodiments allows for the system to be implemented within any physical branch, including mobile branches capable of changing location in response to user need.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method for facilitating operations for a user with a service entity, the method comprising:
receiving, by communications hardware, a service entity request pertaining to the user within a proximity interaction region, wherein the service entity request comprises (a) an indication of a service entity identity that corresponds to a service entity of interest to the user, (b) a user identifier for the user, and (c) a user credential;
determining, by operations management circuitry, a service entity configuration set for the service entity, wherein the service entity configuration set is indicative of a service entity device that is associated with the service entity;
initiating, by communications hardware, a session with the service entity device using a session establishment request, wherein the session establishment request comprises the user identifier and the user credential;
receiving, by the communications hardware, a session establishment response from the service entity device, wherein in an instance in which the service entity device successfully authenticated the user, the service establishment response comprises (a) a session token and (b) user account data pertaining to a user account managed by the service entity and that corresponds to the user;
generating, by interface circuitry and based on the service entity configuration set and the user account data, service entity user interface data; and
providing, by the communications hardware, the service entity user interface data.

2. The method of claim 1, further comprising;
receiving, by the communications hardware, an operation request pertaining to the user, wherein the operation request comprises a service request type and one or more service request parameters;
generating, by the operations management circuitry, a service entity operation request, wherein service entity operation request comprises (a) the session token and (b) the service request type and the one or more service request parameters; and
providing, by the communications hardware, the service entity operation request to the service entity device.

3. The method of claim 2, further comprising:
receiving, by the communications hardware, a service entity operation response from the service entity device, wherein (a) the service entity operation response is indicative that an operational flow corresponding to the service request type was successfully performed and (b) the service entity operation response comprises updated user account data;
generating, by the interface circuitry and based on the service entity configuration set and the service entity operation response, updated service entity user interface data; and
providing, by the communications hardware, the updated service entity user interface data.

4. The method of claim 2, further comprising:
receiving, by the communications hardware, a service entity instruction message from the service entity device, wherein the service entity instruction message comprises instructions to perform an interaction with the user; and
providing, by the communications hardware, an instruction message to an agent device, wherein the instruction message comprises instructions to perform the interaction with the user.

5. The method of claim 4, wherein the interaction with the user comprises at least one of (a) providing the user with a currency amount, (b) receiving a currency amount from the user, (c) providing the user with a document corresponding to a document type, or (d) receiving a document corresponding to a document type from the user.

6. The method of claim 1, further comprising:
receiving, by the communications hardware, an escalation request from the user, wherein the escalation request comprises a request to connect to a representative associated with the service entity;
providing, by the communications hardware, a live user session request to the service entity device, wherein the live user session requests comprises the session token and a request to connect the user to an available representative;
receiving, by the communications hardware, a live user session response from the service entity device, wherein the live user session response comprises a session link to establish a live session between the user and a representative; and
providing, by the communications hardware, the live user session response.

7. The method of claim 1, further comprising:
determining, by the operations management circuitry, a session termination event;
in response to determining the session termination event, terminating, by the communications hardware, the session with the service entity device; and
clearing, by the operations management circuitry, the session token from an associated memory.

8. The method of claim 1, further comprising:
determining, by operations management circuitry, a user inquiry from the user;
generating, by the operations management circuitry and based on the service entity configuration set, an agent script, wherein the agent script comprises dialogue for an agent to answer the user inquiry; and
providing, by the communications hardware, the agent script to an agent device.

9. The method of claim 1, further comprising:
generating, by operations management circuitry, a virtual agent object comprising a default virtual avatar;
providing, by the communications hardware, the virtual agent object; and
in response to determining a service entity configuration set associated with the service entity, replacing, by the operations management circuitry, the default virtual avatar with a service entity virtual avatar described by the service entity configuration set.

10. The method of claim 9, further comprising:
generating, by the operations management circuitry and based on the service entity configuration set, a virtual agent script, wherein the virtual agent script comprises dialogue to interact with the user; and
providing, by the communications hardware, the virtual agent script.

11. The method of claim 1, further comprising encrypting, by cryptographic circuitry and based on the service entity configuration set, the session establishment request using a cryptographic key associated with the service entity device.

12. The method of claim 1, further comprising decrypting, by cryptographic circuitry and based on the service entity configuration set, the session establishment response using a cryptographic key.

13. The method of claim 1, further comprising:
receiving, by communications hardware, a second service entity request pertaining to the user, wherein the second service entity request comprises (a) an indication of a service entity identity that corresponds to a second service entity of interest to the user, (b) a second user identifier for the user, and (c) a second user credential;
determining, by operations management circuitry, a service entity configuration set for the second service entity, wherein the second service entity configuration set is indicative of a second service entity device that is associated with the second service entity;
initiating, by communications hardware, a session with the second service entity device using a second session establishment request, wherein the second session establishment request comprises the second user identifier and the second user credential;
receiving, by the communications hardware, a second session establishment response from the second service entity, wherein in an instance in which the second service entity device successfully authenticated the user, the second service establishment response comprises (a) a second session token and (b) second user account data pertaining to a user account for the user managed by the second service entity;
generating, by interface circuitry and based on the second service entity configuration set and the user account data, second service entity user interface data; and
providing, by the communications hardware, the second service entity user interface data.

14. The method of claim 13, further comprising:
in response to receiving the second service entity request, determining, by the operations management circuitry, a session termination event;
in response to determining the session termination event, terminating, by the communications hardware, the session with the service entity device; and
clearing, by the operations management circuitry, the session token from an associated memory.

15. The method of claim 1, further comprising:
receiving, by the communications hardware, temporal population data;
determining, by location determination circuitry based on the temporal population data, a location of interest;
assigning, by the location determination circuitry, the location of interest as a future operation location; and
providing, by the communications hardware, the future operation location and operating hours.

16. An apparatus for facilitating operations for a user with a service entity, the apparatus comprising:
communications hardware configured to:
receive a service entity request pertaining to the user within a proximity interaction region, wherein the service entity request comprises (a) an indication of a service entity identity that corresponds to a service entity of interest to the user, (b) a user identifier for the user, and (c) a user credential;
operations management circuitry configured to:
determine a service entity configuration set for the service entity, wherein the service entity configuration set is indicative of a service entity device that is associated with the service entity;
wherein the communications hardware is further configured to:
initiate a session with the service entity device using a session establishment request, wherein the session establishment request comprises the user identifier and the user credential, and
receive a session establishment response from the service entity device, wherein in an instance in which the service entity device successfully authenticated the user, the service establishment response comprises (a) a session token and (b) user account data pertaining to a user account managed by the service entity and that corresponds to the user; and
interface circuitry configured to:
generate, based on the service entity configuration set and the user account data, service entity user interface data; and
wherein the communications hardware is further configured to provide the service entity user interface data.

17. The apparatus of claim 16, wherein the communications hardware is further configured to receive an operation request pertaining to the user, wherein the operation request comprises a service request type and one or more service request parameters;
wherein the operations management circuitry is further configured to generate a service entity operation request, wherein service entity operation request comprises (a) the session token and (b) the service request type and the one or more service request parameters; and
wherein the communications hardware is further configured to provide the service entity operation request to the service entity device.

18. The apparatus of claim 17, wherein the communications hardware is further configured to receive a service entity operation response from the service entity device, wherein (a) the service entity operation response is indicative that an operational flow corresponding to the service request type was successfully performed and (b) the service entity operation response comprises updated user account data;
wherein the interface circuitry is further configured to generate, based on the service entity configuration set and the service entity operation response, updated service entity user interface data; and
wherein the communications hardware is further configured to provide the updated service entity user interface data.

19. The apparatus of claim 17, wherein the communications hardware is further configured to:
receive a service entity instruction message from the service entity device, wherein the service entity instruction message comprises instructions to perform an interaction with the user; and
provide an instruction message to an agent device, wherein the instruction message comprises instructions to perform the interaction with the user.

20. A computer program product for facilitating operations for a user with a service entity, the computer program product comprising at least one non-transitory computer-readable storage medium storing software instructions that, when executed, cause an apparatus to:
receive a service entity request pertaining to the user within a proximity interaction region, wherein the service entity request comprises (a) an indication of a service entity identity that corresponds to a service entity of interest to the user, (b) a user identifier for the user, and (c) a user credential;
determine a service entity configuration set for the service entity, wherein the service entity configuration set is indicative of a service entity device that is associated with the service entity;
initiate a session with the service entity device using a session establishment request, wherein the session establishment request comprises the user identifier and the user credential;
receive a session establishment response from the service entity device, wherein in an instance in which the service entity device successfully authenticated the user, the service establishment response comprises (a) a session token and (b) user account data pertaining to a user account managed by the service entity and that corresponds to the user;
generate, based on the service entity configuration set and the user account data, service entity user interface data; and
provide the service entity user interface data.

21-40. (canceled)
